(19) United States
(12) Patent Application Publication
(10) Pub. No.: US 2006/0031187 A1
(43) Pub. Date: Feb. 9, 2006

(54) Systems and methods for enterprise-wide visualization of multi-dimensional data

(75) Inventors: John D. Pyrce, Naperville, IL (US); Jonathon H. Luers, Westchester, IL (US); William Swanson, Elgin, IL (US)

Correspondence Address: OLIFF & BERRIDGE, PLC, P.O. BOX 19928, ALEXANDRIA, VA, 22320, US

(73) Assignee: ADVIZOR SOLUTIONS, INC., DOWNERS GROVE, IL (US)

(21) Appl. No.: 11/196,747

(22) Filed: Aug. 4, 2005

Related U.S. Application Data
(60) Provisional application No. 60/598,420, filed on Aug. 4, 2004.

(51) Int. Cl. G06F 17/30; G06F 9/46; G06F 15/16; G06F 17/24

(52) U.S. Cl. 707/1; 719/328; 709/203; 715/501.1

(57) ABSTRACT

Systems and methods are described that allow powerful multi-dimensional visualization applications to be effectively deployed across large enterprises. The approach employs a zero-footprint client architecture that allows any network (or Internet) connected client device with a web browser that supports industry standard dynamic HTML (i.e., HTML, images and JavaScript) to conduct sophisticated, interactive visualizations of multi-dimensional data. Technical complications and costs associated with large scale deployments are avoided, because client devices are not required to install or execute specialized client-based software. Client actions (e.g., mouse clicks, mouse drags, related screen pointer coordinates, etc.) may be translated into method and application interface (API) calls and transmitted, either directly from a client device or via a visualization web service, to a central visualization server. The visualization server may then generate updated visual components and may relay them back to the client device either directly or via the visualization web service.

### CROSS-REFERENCE TO RELATED APPLICATIONS

This application incorporates by reference in its entirety U.S. Provisional Patent Application No. 60/598,420, entitled “Advizor Server,” filed on Aug. 4, 2004.

### BACKGROUND

1. Field of Invention

This invention relates to visualizing multiple-dimension data.

2. Description of Related Art

With the decreasing cost of storage and increased bandwidth of networks, storing large volumes of fine grain data has become technically feasible and cost effective. In business environments, this fine grain data typically includes, for example, transactions, sales records, and/or customer information. This fine grain data is typically stored in warehouses or data marts. When properly analyzed, this fine grain data provides a rich analysis source for understanding customer behavior.

Transactions collected by operational systems are frequently stored in relational tables. For a variety of reasons, including data cleanliness, scalability, efficiency of the relational method, difficulty in building schemas, and computational complexity, analyzing, understanding, and making business decisions using raw relational tables is difficult. Unfortunately, the relational model and the standard interface of the structured query language (SQL) used to manipulate relational tables, as described in “A Guide to the SQL Standard,” C. J. Date et al, Addison-Wesley, Reading, Mass., 1997, are not always well-suited for analysis tasks. When submitted against warehouses that have been engineered for fast transaction archiving, analysis queries frequently run extremely slowly. For example, a multi-million dollar warehouse may only be able to support one or two power analysis users.

One conventional approach for overcoming the analysis problem promulgated by business intelligence software vendors involves aggregating transactions into multi-dimensional databases. One standard interface for understanding and manipulating multi-dimensional data is called a “pivot table” or “cross tab.” Although there are variations among particular vendors' implementations, FIG. 1 shows an example of a Microsoft Excel® pivot table. As shown in FIG. 1, in a Microsoft Excel® pivot table 10, the cells are arranged in a “row by column by page” grid, with only one page being displayed at any time. The value of the column dimension 20 (the “product” dimension in FIG. 1), the row dimension 30 (the “state” dimension in FIG. 1), and the page dimension 40 (the “QTR” dimension in FIG. 1) are used to index the table cells and adjust the displayed page. In the pivot table 10 shown in FIG. 1, each cell contains five measures: sales 50, expenses 51, profit 52, cost of goods sold (COGS) 53, and marketing 54. For each measure, the margin 55 is totaled along the edges. The grand totals are totaled in the lower right hand corner (not shown in FIG. 1). The row dimension 20, i.e., the product dimension, is organized into a two-level hierarchy that includes a higher-level “product_type” dimension 21 and the low-level “product” dimension 22 nested within the “product_type” dimension 21.

U.S. Pat. No. 6,707,454, entitled “Systems and Methods for Visualizing Multi-Dimensional Data in Spreadsheets and Other Data Structures,” issued Mar. 16, 2004, and incorporated by reference in its entirety into this document, describes systems and methods that facilitate the visualization of multi-dimensional data. The visualization systems and methods described in U.S. Pat. No. 6,707,454 are applicable to any multi-dimensional visualization application in which large amounts of data may be analyzed to extract useful information. Such applications may include, but are not limited to, applications in risk and portfolio management, customer analysis, market research, and network security analysis.

Unfortunately, the number of large-scale deployments of multi-dimensional visualization applications has been limited. One reason for the limited number of large-scale multi-dimensional visualization application deployments is that existing multi-dimensional visualization system architectures require software to be installed on the client device, or end-user computer. For example, one exemplary web-enabled multi-dimensional visualization system architecture may include software program instructions written in Java or ActiveX, and/or or vector graphics that use Flash or SVG formats, that are executed by a client device. However, such client device software technologies are not supported by standard client device web browsers. Therefore, such an architecture requires the client device web browser to be enhanced with one or more software “plug-in” applications in order for the client device browser to execute the software program instructions and/or to view graphics received from a remote multi-dimensional visualization system server.

Unfortunately, technologies such as ActiveX may have security and configuration related issues. Technologies such as Java may have issues related to installation and version. Further, while vector drawing techniques, such as Flash and SVG, can make pretty charts, they do not support complex interactions between a user and the visualized data. Therefore, an architecture that requires one or more of the above technologies to be loaded upon a client device introduces installation, configuration, and operational complexities that would not be introduced by an architecture that does not require such client device technologies. Similar problems are likely to be introduced by any multi-dimensional visualization system architecture that requires additional software to be loaded upon a client device.

FIG. 2, presents a schematic diagram of an exemplary multi-dimensional visualization system 2100 that is based upon an architecture that requires additional software, or “plug-in” software as described above, to be installed upon on the client device. As shown in FIG. 2, web-enabled client device 2102 may communicate with a visualization server 2106 over a network 2108. Using standard web-browser capabilities, client device 2102 is able to receive web pages and web-based downloads. However, in order to operate as a visualization client, client device 2102 must first receive and install plug-in software modules. Only once such plug-in software modules have been received and successfully installed, is client device 2102 able to receive and display visualization content from server 2106 and/or interact with server 2106 with respect to the visualization content. Therefore, visualization system 2100 encompasses software components on client device 2102 and software components on server 2106.

The plug-in download and installation process, described above with respect to FIG. 2, may be subject to issues that render client device 2102 un-usable as a visualization client. For example, an office user working from home may only have slow dial-up access, and the requirement to download and install a new component for the home computer would limit their ability to immediately see results. Alternatively, a corporate user may not have sufficient privileges to download and install a plug-in software module (e.g., a latest version of Java or Flash, etc.) to the client device. The lost time and added cost of having the IT department intercede increases the overall burden and frustration with such a system.

Furthermore, such client-based technologies may be affected by idiosyncrasies within the hardware and software of the client device. For example, it is not uncommon to find a client device in which the graphics card has glitches in certain modes, and these glitches may impact the performance and usability of the client device for visualization.

Visualization system architectures that employ client-based technologies may experience significant deployment related difficulties. For example, under the following enterprise deployment scenarios, a visualization system that uses client-based technology is likely to experience significant deployment related technical issues:

A growing global business brings on new employees around the world. Users in different countries have wide variances in the configuration of the computers and do not have a local IT group to support and assist them with adding new features or software.

A government organization wants to disseminate public data on the Internet in an easy to use fashion. Visualization is ideal, because it can communicate patterns in data through simple, visual pictures. The user community, however, uses a wide variety of technologies, such as Macintosh computers in schools, Unix computers in research institutions, etc., making any kind of platform-specific solution unacceptable.

A customer-focused organization wants to present customer account information using visual techniques. Visualization provides the customer with more insight into the information, helping them better understand their business, their relationship with the organization and where opportunities for additional discounts may be. However, the organization cannot afford to support these users with any special technology.

Hence, a need remains for systems and methods that may be used to effectively deploy multi-dimensional data visualization capabilities. Preferably, such an approach would not require the loading of additional software upon a client device, yet would provide the user of the client device with accesses to sophisticated multi-dimensional data visualization capabilities. Further, such an approach would preferably be capable of deploying multi-dimensional data visualization capabilities that allow a user to dynamically interact with multi-dimensional visualization content and thereby extract useful information from the data. In addition, such an approach would preferably support simultaneous visualization sessions without overburdening server processor and/or network bandwidth resources.

### SUMMARY

Systems and methods are described for a multi-dimensional visualization system that may effectively deploy multi-dimensional data visualization capabilities across large enterprises. The approach uses a zero-footprint client architecture that allows a network (or Internet) connected remote display device, such as a client device with a web browser that supports industry standard dynamic HTML (e.g., HTML, images and JavaScript), to conduct sophisticated, interactive visualizations of multi-dimensional data.

Technical complications and costs associated with large scale deployments are avoided, because client devices are not required to install or execute specialized client-based software. Client actions (e.g., mouse clicks, mouse drags, related screen pointer coordinates, etc.) may be translated into, for example, method and/or application interface (API) calls to a central visualization server. If the method and/or application interface (API) calls are generated by the client web browser or scripts embedded within a displayed HTML document, the method and/or application interface (API) calls may be transmitted directly from the client to the visualization server. Otherwise, the client web browser may transmit recorded client actions to a central visualization web service that may translate the recorded user actions into method and/or application interface (API) calls compatible with the visualization server and then may transmit the method and/or application interface (API) calls to the visualization server. In response to receiving such method and/or application interface (API) calls the visualization server may generate updated visual components, or visualization graphics, (e.g., multi-dimensional visualization graphics, graphics with embedded text, etc.) and relay the updated visual components back to the client device, either directly or via the visualization web service.

The described visualization systems and methods do not depend on the operating system of the client device. For example, Macintosh®, UNIX®, Linux® and all versions of Microsoft Windows® and any other operating system capable of supporting a web browser is supported. Client devices may include any web-enabled device, including laptop computers, personal digital assistants (PDAs), tablet computers and phones.

The described systems and methods for implementing an enterprise-wide multi-dimensional data visualization application/system are based upon a client “zero-footprint” architecture that allows any web-enabled client to visualize large amounts of data, and to dynamically interact with the visualized data, or visualization. The approach is easy to deploy, easily maintained and will support users distributed throughout a highly diverse operational infrastructure. However, the approach requires no more network bandwidth per client session than a typical web browsing session.

These and other features and advantages are described in or are apparent from the following detailed description of various exemplary embodiments of the systems and methods.

### BRIEF DESCRIPTION OF THE DRAWINGS

The patent or application filed contains at least one drawing executed in color. Copies of this patent or patent application publication with colored drawings will be provided by the U.S. Patent and Trademark Office upon request and payment of the necessary fee.

Various exemplary embodiments will be described in detail, with reference to the following figures, wherein:

FIG. 1 is an exemplary Microsoft Excel® pivot table;

FIG. 2 presents a schematic diagram of a multi-dimensional data visualization system that requires deployment of client-based “plug-in” technologies;

FIG. 3 presents a schematic diagram of a multi-dimensional data visualization system that is based upon an exemplary zero-footprint architecture;

FIG. 4 presents a system-level block diagram of an exemplary web-based multi-dimensional data visualization system;

FIG. 5 presents a block diagram of an exemplary multi-dimensional data visualization module within the exemplary web-based multi-dimensional data visualization system presented in FIG. 4;

FIG. 6 presents a block diagram of data source relationships within the exemplary web-based multi-dimensional data visualization system presented in FIG. 4;

FIG. 7 is one exemplary embodiment of a single measure perspective;

FIG. 8 is a first exemplary embodiment of a multiple measures perspective;

FIG. 9 is a second exemplary embodiment of the multiple measures perspective;

FIG. 10 is one exemplary embodiment of an anchored measures perspective;

FIG. 11 is a first exemplary embodiment of a navigation toolbar that is usable to navigate through data cubes and the various perspectives;

FIG. 12 is a second exemplary embodiment of a navigation toolbar that is usable to navigate through data cubes and the various perspectives;

FIG. 13 illustrates the application of the “exclude” function on the exemplary single measure perspective of FIG. 7;

FIGS. 14 and 15 illustrate the linkage between the bar chart views and the multiscape view in the exemplary embodiment of the single measure perspective shown in FIG. 7;

FIG. 16 is a process flow diagram depicting an exemplary interaction between a client browser, the visualization web service and the visualization server in support of an exemplary client browser initiated visualization session;

FIGS. 17 and 18 illustrate exemplary HTML documents with embedded visualization graphics that facilitate the presentation of data within the context of a report;

FIG. 19 is an exemplary HTML document with embedded visualization graphics in which the “focus” event is used to demonstrate a user's ability to emphasize data of interest within the respective visualization graphics presented in the HTML document;

FIGS. 20 and 21 are exemplary views of an HTML document with embedded visualization graphics in which the “selection” event is used to demonstrate a user's ability to emphasize data of interest and to de-emphasize data other than data of interest within the respective visualization graphics presented in the HTML document; and,

FIGS. 22 and 23 are exemplary views of an HTML document with embedded visualization graphics in which the “drill-down” event is used to demonstrate a user's ability to emphasize data of interest and to de-emphasize (by removing from the respective graphics) data other than data of interest within the respective visualization graphics presented in the HTML document.

### DETAILED DESCRIPTION OF EMBODIMENTS

System and method embodiments are described below with reference to the above drawings, in which like numerals designate like components.

The described systems and methods relate to a novel approach for providing users with access to multi-dimensional data visualization capabilities. The approach includes an architecture that allows any web-enabled client that supports receipt of HTML web pages to act as a multi-dimensional data visualization client. The architecture does not require the remote display device, such as a client device with a web browser that supports industry standard dynamic HTML (e.g., HTML, images and JavaScript), to download and install additional or “plug-in” software. Further, a client device does not require any additional client device processing or network bandwidth resources above that which would be required by the client device to receive HTML web pages. Although the architecture requires processing and storage resources provided by one or more centralized servers that are accessible to the respective client devices over a network (as described below), because the architecture requires no additional client executed software in addition to the client software (e.g., client operating system, web browser, network connectivity software, etc.) required by the client device to receive conventional HTML and dynamic HTML (e.g., HTML, images and JavaScript) web pages, the architecture may be referred to as a “zero-footprint” architecture.

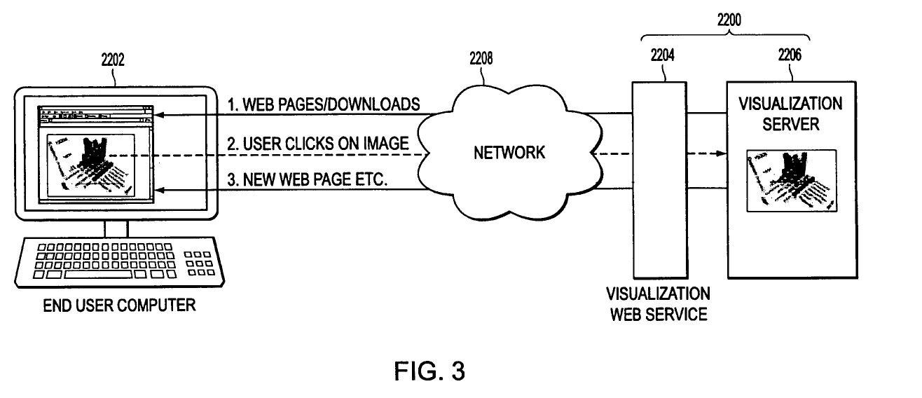

FIG. 3 presents a schematic diagram of a deployed multi-dimensional data visualization system 2200 that is based upon an exemplary zero-footprint architecture that does not require additional software to be installed on the client device, as described above. As shown in FIG. 3, using a zero-footprint architecture, web-enabled client device 2202 may communicate via visualization web service 2204 with a multi-dimensional data visualization server 2206 over a network 2208. Using standard web-browser network capabilities, client device 2202 may receive web pages and web-based downloads. However, the HTML pages received by the client device may include visualized displays of multi-dimensional data that are generated by visualization web service 2204, as described in greater detail below. Further, a user may interact with the presented visualization via client device 2202 using standard web-browser supported I/O operations (e.g., point-and-click, point-and-drag, double-click mouse operations). Input/output actions performed by the user and the screen coordinates associated with each action may be conveyed (e.g., by JavaScript routines embedded in the HTML document) to visualization web service 2204. Visualization web service 2204 may receive the recorded actions and screen coordinates and may translate the user actions received for each client device visualization session into appropriate method and application interface (API) calls which visualization web service 2204 may submit to visualization server 2206. Visualization server 2206 may generate updated visual components and may relay the updated visual components back to visualization web service 2204. In response, visualization web service 2204 may transmit the updated visual components to the appropriate client device for display.

Therefore, from a user's perspective, the visualization results received from visualization server 2206 at client device 2202, in response to interactive actions performed by the user, are the same, or similar, to the visualization results that would have been displayed were the visualization server 2206 locally installed on the client device. As stated above, visualization system 2200 is based upon a zero-footprint architecture. Therefore, client device 2202 configured with a standard web browser is able to operate as a visualization client without the need to install additional or visualization system specific components. Therefore, visualization system 2200 encompasses software components on visualization web service 2204 and visualization server 2206.

Visualization web service 2204 may provide visualization server 2206 with connectivity to client device 2202 in a zero footprint web environment. In one exemplary embodiment, visualization web service 2204 may be implemented with Microsoft ASP.Net as a host for visualization server 2206. Visualization web service 2204 may return an HTML web page that includes one or more visualization graphics, or graphical views, generated by visualization server 2206.

Rather than being connected to an interactive window, the user actions (e.g., clicks, cursor drags, etc.,) with respect to the visualization graphics embedded in the HTML web pages may be conveyed to visualization web service 2204 and interpreted by visualization web service 2204 into method and API calls sent to visualization server 2206.

For example, an initial XML document (or manifest) that defines a set of components for inclusion within an initial visualization session display may be sent from client device 2202, upon initiating a session, to visualization web service 2204. The manifest may be translated by visualization web service 2204 into method and API calls sent to visualization server 2206. These method and API calls may result in visualization server 2206 generating and returning to visualization web service 2204 a set of initial visualization graphics, which visualization web service 2204 may include, within an initial visualization session HTML document returned to the client device that initiated the session. The returned visualization session HTML document with embedded visualization graphics may include JavaScript routines that record and transmit user's subsequent actions to visualization web service 2204, resulting in client device 2204 receiving subsequent visualization graphics that reflect updates based upon the recorded user actions.

For example, user actions such as selections, panning, and zooming actions may be recorded by JavaScript routines embedded within a visualization web service generated HTML document. The recorded actions may be transmitted to visualization web service 2204 to produce updates to visualization graphics displayed upon client device 2202. Other user actions recorded for transmission to visualization web service 2204 may include user actions related to, for example, loading data to visualization server 2206 from external data sources (e.g., databases, text files, CSV files, a URL, etc.), or, for example, exporting data from the from visualization server 2206 to external data stores.

In one exemplary embodiment, visualization web service 2204 may be installed to a Microsoft IIS Web Server. Exemplary methods and APIs that may be available in such an embodiment may allow visualization web service 2204 to control operation of visualization server 2206 visual components (described in greater detail below) and data pool tables (also described in greater detail below) are listed in Table 1 and Table 2, below, respectively. The basic paradigm in which the methods and APIs listed in Tables 1 and 2 may be used may include:
1. Creating a session. A session may be created from a “manifest,” an XML document listing the components and their initial properties to be created in the session. Alternatively a default session may be generated in response to a user request based upon a stored default manifest. The default visualization session may then be modified by subsequent user actions against the default visualization.
2. Retrieving visualization graphics (e.g., graphics images) from visualization server for inclusion in a visualization session web page. These visualization graphics may be displayed in generated HTML web pages transmitted to a client device using the “<img>” tag.
3. Getting user interactions on visualizations and applying them to the respective visualization components as keyboard, mouse, or focus events. Retrieve updated images for visualization components that have changed based on the user's interactions.

4. Updating the images in the HTML page with the new visualization graphics.

TABLE 1
Exemplary Visualization Web Service Methods

| | |
|---|---|
| ChangeDataPool | Change to the named Data Pool for subsequent |
| | actions. |
| ChangedViewList | Return the list of views visual components with |
| | pending updates. |
| ColorTable | Apply a custom color scale to a table. |
| CreateEmptySession | Create a new empty session. |
| CreateSession | Create a new session based on a manifest, an |
| | XML document describing the components and their |
| | initial properties. |
| CreateView | Add a new visual component in a session. |
| DeleteSession | Delete an existing session. |
| ExecuteCommand | Execute a command on a component. |
| FindSelectedValues | Find the set of selected values. |
| FocusEvent | Applies a focus event to a view visual component |
| | within a session. |
| GetProperty | Retrieves a property value from a view visual |
| | component. |
| GetZoomParams | Retrieve the zoom parameters for a component. |
| KeyEvent | Apply a keyboard event to a view visual component |
| | in a session. |
| LinkTable | Create a linkage between two tables. |
| LoadData | Load the data for a session from a URL. |
| MouseEvent | Apply a mouse event to a component in a session. |
| Ping | Determine if a session is active |
| RetrieveImage | Retrieve the image for a component. |
| ServerVersion | Returns the version of the server. |
| SetProperty | Set a property of a component. |
| SetZoomParams | Set the zoom parameters for a component. |

As described above, an exemplary embodiment of visualization web service 2204 may be designed as a resource for generating interactive multi-dimensional data visualization graphics for inclusion within a visualization session HTML document. The generated visualization graphics may be manipulated using controls embedded within the HTML document and/or visualization graphics. For example, JavaScript functions embedded within the HTML documents and/or visualization graphics displayed upon a client device may implement standard interactions such as: rubber banding a rectangle with the mouse for graphical selection, context menus, keyboard events, and zoom bars. Further, these JavaScript functions may automatically interface with visualization web service 2204 API to convey these events and retrieve updated visualization graphics.

In one exemplary embodiment, an HTML web page consistent with use of the functions described above may be automatically created by processing a Microsoft FrontPage® compliant HTML document with a macro that may be executed by visualization web service 2204 that replaces the “<object>” tags used for ActiveX component objects with “<img>” tags, writes the list of components and their properties to an XML “manifest” file, and includes references to the necessary JavaScript definitions.

Visualization server 2206 may be implemented as an open system visualization server. In such an embodiment, visualization server 2206 may be accessed by any web application implemented using any web based technology including ASP, ASP.Net, Java J2EE, or CGI. In such an exemplary embodiment, visualization web server 2204 may generate an HTML web page for display upon a client browser such that the web page communicates directly with visualization server 2206. In such an embodiment, visualization web server 2204 may continue to generate and transmit to the client device HTML with information received from visualization web server 2206, however, user interactions may be applied directly to visualization server 2206 using the standard JavaScript user interface elements described above. Alternatively, visualization web service 2204 may serve as an intermediary in all interactions between the client browser and visualization server 2206. For example, visualization web service 2204 may receive all actions from the client device and relay them to visualization server 2206. Further, visualization web service 2204 may receive all generated visualization graphics generated by visualization server 2206 and relay them to the client device.

In one exemplary embodiment, visualization web service 2204 may create a session tracking data store for each visualization session created by a client device 2202. Such a session tracking data store may be retained by the web service as long as the session is active. Preferably, the session tracking data store is stored on the server for the life of the session to assure rapid access to all session related information.

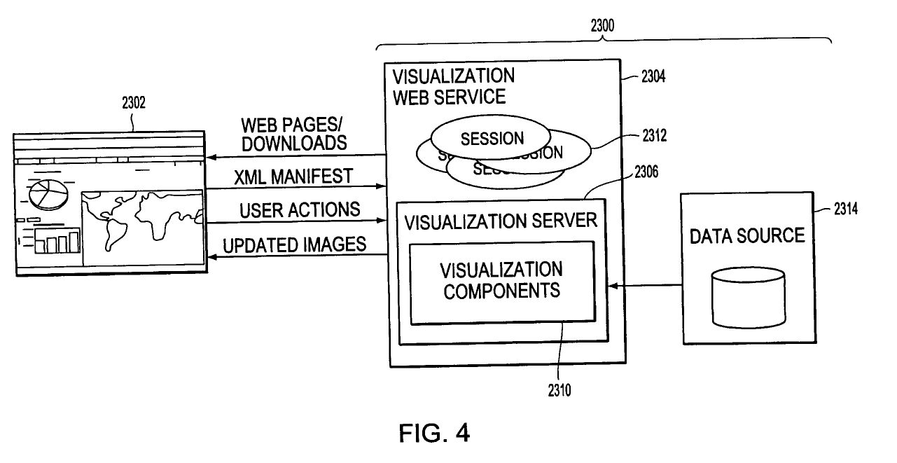

FIG. 4 is a schematic diagram of a second exemplary embodiment of a multi-dimensional data visualization system 2300 based upon an exemplary zero-footprint architecture. Visualization system 2300 may include a visualization web service 2304, a visualization server 2306 with visualization components 2310 and a data source 2314. As shown in FIG. 4, visualization system 2300 may communicate with a client device 2302 configured with a standard web browser that is able to receive web pages and web-based downloads.

In operation, client device 2302 may request, via a network connection (e.g., LAN, WAN, Internet, etc.) a URL resource (e.g., an HTML web page) on visualization web service 2304. The downloaded HTML page may allow client device 2302 to initiate a visualization session with visualization web service 2304 based upon instructions received from client device 2302. For example, JavaScript routines within the downloaded HTML web page may allow the user to specify an initial set of visualization session characteristics and transmit the characteristics to visualization web service 2304 as an XML document (or manifest), as described above. Upon receipt of the XML manifest document, visualization web service 2304 may define a visualization session 2312 that may include reservation of a session data store that allows visualization web service 2304 to track the status of the visualization session.

For example, an HTML web page downloaded by client device 2302 may allow a user to select one or more databases, select graphics (or visualization components), and/or specify an initial arrangement of the visualization components included in the visualization session. The information input by the user may, for example, replace default values stored within a default XML manifest. At the user's request for a new visualization session, client device 2302 may transmit the XML manifest to visualization web service 2304. Upon receipt of the manifest, visualization web service 2304 may initiate a new visualization session 2312, interpret the XML manifest into a set of initial session control values and method and/or API calls, and submit the method and/or API calls to visualization server 2306. In response, visualization server 2306 may generate and submit to one or more visualization components 2310, requests for one or more multi-dimensional graphical views that correspond to the configuration requested in the default, or user specified, manifest and that are based upon data made accessible to the respective visualization components 2310 by data source 2314. Upon completion of the requested graphics views by visualization components 2310, visualization server 2306 may forward the generated graphical views to visualization web service 2304. Visualization web service 2304 may then generate and transmit to client device 2302 an HTML web page containing the generated graphics views.

As described above with respect to FIG. 3, a user may interact with an HTML based visualization via client device 2302 using standard web-browser supported I/O operations (e.g., point-and-click, point-and-drag, double-click mouse operations). Input/output actions performed by the user and the screen coordinates associated with each action may be conveyed (e.g., by JavaScript routines embedded in the HTML document) to visualization web service 2304. Visualization web service 2304 may receive the recorded actions and screen coordinates and may translate the user actions received for each client device visualization session into appropriate method and application interface (API) calls which visualization web service 2304 may submit to visualization server 2306. The visualization server 2306 may then generate updated graphical views and may relay the updated graphical views back to visualization web service 2304. In response, visualization web service 2304 may transmit the updated graphical views to the appropriate client device.

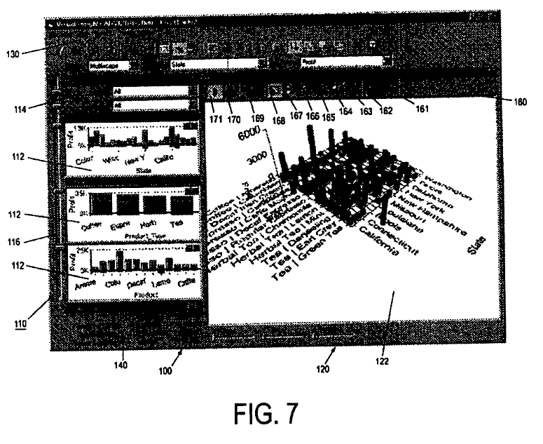

As discussed in greater detail below with respect to FIGS. 7-15, actions performed by the user at client device 2302 and relayed to visualization server 2306 may change any aspect of the multi-dimensional data visualization presented to the user. Each set of actions performed by the user may result in presentation upon client device 2302 of an updated visualization which is the same, or similar, to the visualization results that would have been displayed were the visualization server 2306 locally installed on the client device.

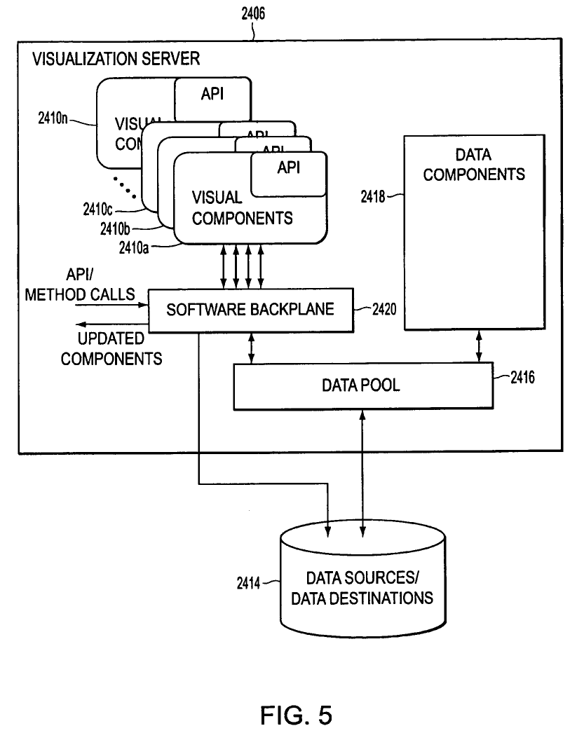

FIG. 5 presents a block diagram of an exemplary multi-dimensional data visualization server 2406, described above with respect to FIG. 4 (at block 2306). As shown in FIG. 5, visualization server 2406 may include a software backplane 2420 in communication with one or more visual components 2410(a-n), and a data pool 2416. Further, visualization server 2406 may include one or more data components 2418 that may operate upon information tables stored in data pool 2416. Data may be received by visualization server 2406 from data sources 2414 (e.g., local/remote databases, text files, spreadsheets and other applications) via data pool 2416.

Software backplane 2420 may coordinate operations among the other components within visualization server 2406. Each visual component 2410(a-n) may embody a particular visual representation, including conventional graphs such as bars, pies, and lines, as well as other special purpose presentation formats. Data pool 2416 may be a set of in-memory data tables available to be visualized by one or more visual component 2410(a-n). Data components 2418 may directly manipulate data stored in data pool 2416 based upon a variety of actions and events.

Tables in data pool 2416 may be populated from files, databases, or directly via an Application Programming Interface (API).

To generate a visualization, a user may use point and click dialogs presented in a client device web browser via HTML web pages generated by a visualization web service. Using such dialogs, a user may attach one or more tables within data pool 2416 to one or more visualization components 2410(a-n) selected for inclusion in an interactive visualization session, as described in greater detail below.

In one exemplary embodiment, visualization server 2406 may be implemented based upon a C++ class library called Vz, originally developed by Lucent Bell Labs. Vz is an object-oriented, platform-neutral, class library focused on visualization. This library may be packaged for use as Microsoft ActiveX COM objects. The Vz library includes:
objects that handle display rendering in an efficient manner,
objects that contain placement and graph layout algorithms,
objects that factor out common visualization operations such as color management, scales, mouse operation,
objects that include many utility classes for efficient data management, manipulation, conditioning, and transforms,
objects that provide a common “look-and-feel,”
objects that enable efficient 3D navigation,
objects that support visualization linking and event management, and
objects that include statistical algorithms such as smoothing and trending.

In one exemplary embodiment, visualization server 2406 data pool 2416 may be organized using a table-based data model. A table may consist of named columns, each of which contains data elements of a single type. Internally the data within columns may be stored in auto-sizing vectors. The indigenous data types may be string, 32 bit integer, doubles, and dates. The meta data for each table may include house-holding information such as vector names, lengths, access state, etc. Further, two additional vectors may be automatically associated with every table: a selection and color vector. Data within data pool 2416 available to support visualized presentations may be stored in memory.

As described above, data may be added to data pool 2416 from a text file, a collection of text files in a Zip archive, an Excel spread sheet, a database of any type, etc., or by adding the data directly via an API. Text files may be loaded from disk or via a URL over a network. Database and spreadsheet access may be via a component built using Microsoft's ADO library, which may provide access to databases via native drivers or ODBC. Supported data sources may include Microsoft SQL Server, Oracle, and Excel spreadsheets.

Multiple tables in data pool 2416 may be used in a variety of ways. Separate tables may represent data at different levels of abstraction. For example, internet traffic may be modeled as page hits (in one table) and visits to a web site (in a second table). Separate tables may also be used to dynamically download details. In one embodiment, data pool tables may be joined or linked to other tables in the data pool to facilitate use.

Joining tables within the data pool 2416 may be used to combine multiple tables to make them appear as one. This may be an efficient way, to minimize duplication. For example, joining may be used to include repeating data in a table. For example, one table may contain customer details including location, and another table may contain customer transactions. The customer details may be included with the transactions by joining across a unique customer ID. Now customer transactions may be analyzed in terms of customer location.

Linking tables within the data pool 2416 may propagate events between tables. Such a feature may be used, for example, to propagate user data selections and user color selections within a visualization that includes multiple graphical views generated by multiple visual components 2410, with data from multiple data pool 2416 tables. For example, in the internet traffic example above, the page hits table and website visit tables may be separate and represent different events. However, if both tables include a visit identifier, the tables may be linked and the page hits for a visit may all be selected by selecting a visit, or the page hits may be colored based on a visit characteristic (e.g., visit length).

Visualization server 2406 may use events to propagate changes, both user and data initiated, among the visual components and data tables. Events may be made accessible through programming APIs and may be intercepted, generated, and manipulated from a container application. An event may be associated with each data pool 2416 data table and may be propagated using a publish and subscribe programming pattern. Visual components 2410(a-n) may direct events generated by user manipulations, e.g. selections, hiding, focus, etc., to their associated data table, which then may propagate the events to any linked components. In one exemplary embodiment event types may include the following:
Data Changed: may indicate that the underlying data table has been modified and usually causes the component to completely redraw itself;
Visibility Changed: may be triggered for a hiding (or un-hiding) event;
Highlight Changed: may be called for selection events;
Names Changed: may indicate that a variable name in a table has changed;
Color Changed: may occur when the current coloring changes, either by resealing the colors or by selecting a new color scale;
Focus Item Changed: may occur when the focus changes; and
Undo Changed: may occur when a user has selected either undo or redo from the command stack.

In contrast to many visualization components that return raw mouse coordinates and button clicks, data events may be higher level and more oriented toward visualization tasks. To create an animation, for example, a visual component may sequentially generate Highlight Changed events and walk the focus of graphically visualized data over rows in a data table upon which the graphically visualized data is based.

Data within tables in data pool 2416 may also be directly updated using API objects. In on embodiment, the data pool API objects identified in Table 1, below, may be made available for use via the Vz Library as Microsoft ActiveX COM objects, as described above.

TABLE 1
Exemplary Data Pool API Objects

| API Identifier | API Use |
|---|---|
| VzCalculator | Add new fields based on calculations applied to existing |
| | fields. |
| VzColorRange | Represent a color range applied to data. |
| VzDataAppend | Append data to existing table fields. |
| VzDataColor | Control and retrieve coloring of tables and views. |
| VzDataIdentity | Find table and field existence and field data types; |
| | as well as removing tables and fields. |
| VzDataInput | Load text files or URLs, generate tables and fields, and |
| | connection point for progress reports. |
| VzDataOutput | Write tables and fields to files. |
| VzDataQuery | Retrieve selection information and connection point for |
| | change reports using the IVzDataEvents interface. |
| VzDataUpdate | Modify data in a field, selection operations, and undo |
| | control. |
| VzDateCalc | Date transformations on date and numeric data. |
| VzDBAccess | Add data to the data pool from a wide variety of data |
| | sources. |
| VzEnumAccess | Enumerate over tables, fields, and data. |
| VzLinkPool | Create associations between fields and tables. |
| VzLogManager | Log messages to configurable targets. |
| VzProgress | Interface for progress reports during data loading. |
| VzSession | Global component session (undo/redo) management. |
| VzTransaction | Interface to transactions. |

In a preferred embodiment, data pool 2416 tables may be designed and implemented to handle large volumes of data with interactive performance. Such a preferred embodiment would have no built in limitations for data size (i.e., number of tables, number of rows in tables, number of fields in tables) or visualization complexity. Performance and capacity would be limited only by the amount of memory and speed of the CPU hosting the visualization components.

Such a preferred embodiment would comfortably handle hundreds of thousands of items, and may be used to provide visualizations that include millions of items without degradation in response. For data sources that exceed such ranges, some preprocessing of the data may be performed to focus on interesting entities and to yield reasonable data sizes. For example, in an exemplary market basket application, the number of point of sale transactions may be extremely large. However, by processing the data to summarize the interactions between products a reasonably sized data set may be obtained. For example, such data conditioning may be performed using tools such as relational or OLAP databases or other database technologies.

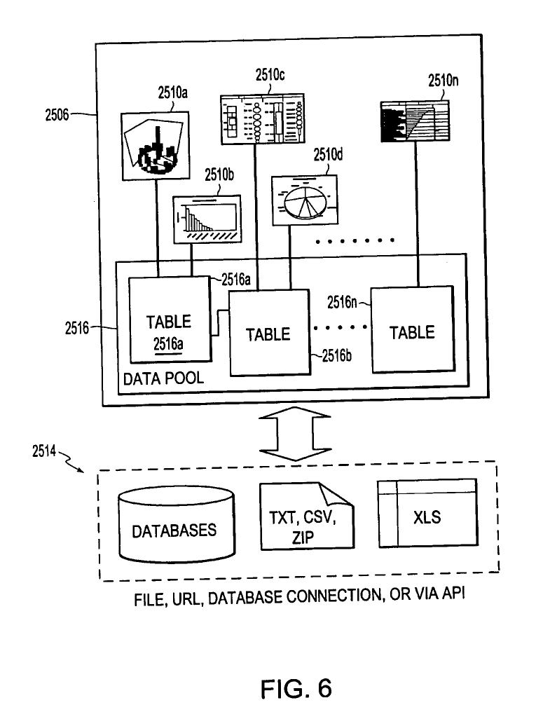

FIG. 6 is a block diagram of exemplary data source relationships within the exemplary web-based multi-dimensional data visualization systems described above with respect to FIGS. 3-5. As shown in FIG. 6, tables 2516(a-n) within data pool 2516 may be populated with data originating from a wide rage of local and/or remote data sources 2514. For example, one or more of tables 2516(a-n) within data pool 2516 may be populated with information from a local or network connected data source including, but not limited to any local or network accessible database and/or .TXT, .CSV, Microsoft Excel, and zip files, and/or any other formatted data.

As described above, data tables within data pool 2516 may be stored in memory and may be attached to one or more visualization server 2506 visualization components 2510(a-n). Once attached to a visualization component, changes in data values may be propagated throughout the system, as described above, so that corresponding and/or related data within related visualization graphics and related data pool tables remain consistent.

For example, data may be loaded into data pool 2516 based upon instructions received from via the client device web browser interface. A user may designate a data store and may request that the information be loaded within the data pool for use in visualizations. In one exemplary embodiment, the user may use an HTML based interface to designate or select a data source location and then use the HTML based interface to identify the data sources to be loaded from the designated location. Such user actions may be stored as an XML document and forwarded to the visualization server that may then translate the user actions into method and/or API calls to implement the load.

Data within the data pool data tables that is modified or combined with other data sources as a result of an interactive visualization session may be exported from the data pool tables using similar user interface mechanisms to identify source data pools and target destinations and to execute the data transfer.

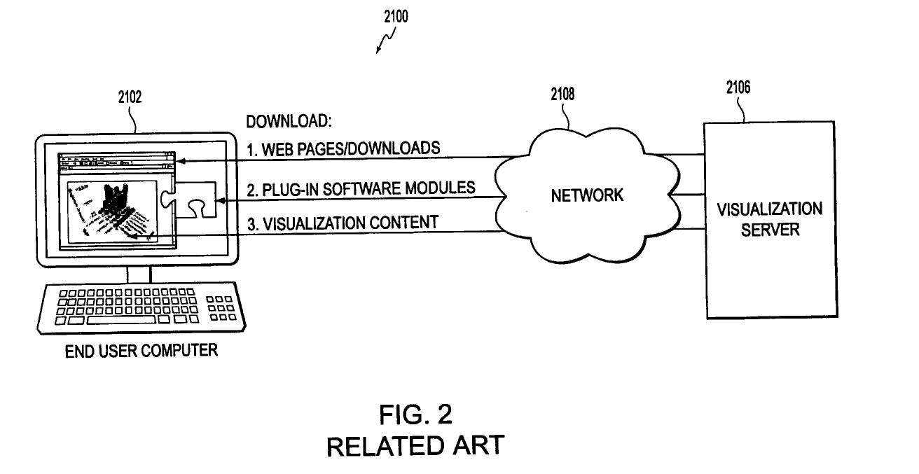

A zero-footprint architecture, as described above, may be used to implement the same visualization techniques that could otherwise be implemented by an architecture that relies upon client-based software, as described above with respect to FIG. 2. Further, a zero-footprint architecture may be used to implement the same multi-dimensional data visualization capabilities supported by a standalone system in which the visualization server is loaded upon the client device. However, a zero-footprint architecture, as described above, provides several significant benefits:
1. No client software installation. There is no need to install any software on the local computer. There are no issues with download sizes, file sizes, disk space, administrator privileges, software versions, virtual machines, or graphics cards configurations. Different kinds of computers and users can access the visualizations.
2. Centralized Administration, Resources and Maintenance. Visualization calculations may be performed by a central server. Such an approach is beneficial because:
   a. Some visualizations may use 1-100+Mb of data. By performing visualization calculations from a central server, the large volumes of data used to support a visualization do not need to be transferred over the network to the client device. This frees up network bandwidth, can reduce end-user wait times and reduces the need for disk space and/or the amount of RAM on the client device. Further, the data upon which visualizations are based is often sensitive proprietary information. By not requiring that the information be transferred across a network, the information remains protected.
   b. Servers often have more computing resources (e.g. more memory, faster processors) than client devices. Thus, power users have access to visualize more data than they would on local computers.
   c. Modifications to the visualization may be performed on the central server.

Nothing needs to be distributed out to the client devices to “upgrade” the visualization.

Thus, the described zero-footprint architecture is an attractive solution to broad deployment of visualization to enterprise end users. End users do not need anything special to view and interact with the visualizations, other than a standard web browser and a network connection. A wide variety of interactions with the data visualization are supported. Central control of the application enables visualization of larger data sets and may reduce network load.

Further, a multi-dimensional data visualization system based upon a zero-footprint architecture may be used together with a multi-dimensional data visualization systems based upon other architectures, such as a client-based architecture, and/or a stand-alone to provide value to all groups of users and types of use within an organization, whether the base of users include broad general users, power users, analytical users, or developers.

As described above, dimensional databases are a particularly useful way to organize business metrics. Multi-dimensional data structures, including pivot tables, are the most widely used tool for manipulating and reporting on these metrics. However, it may be difficult for users to understand and make sense of pivot table data, such as, for example, to see patterns, to identify trends, and to spot outliers, because of the size and textual nature of pivot tables and other multi-dimensional data structures. Often, understanding even a tiny 10 row by 10 column pivot table is difficult, and understanding bigger pivot tables is impossible. Graphical tools supplied by the vendors of such multi-dimensional data structures, such as Microsoft, are generally not scaleable and often not particularly useful.

Accordingly, in practice, the way users conventionally understand large pivot tables is by breaking them up into multiple small tables. Unfortunately, there are three disadvantage in using smaller, reduced-size pivot tables. First, aggregations mask important details. Second, subsets obscure overall patterns. Third, predefined comparisons prevent users from discovering unexpected and unanticipated results.

The multi-dimensional data visualization systems and methods address these problems using a number of different data visualization techniques. In particular, a “single measure” perspective provides an overview of an entire pivot table showing overall patterns, by including at least one view displaying data for only a single measure. One or more multi-measure perspectives, such as a “multiple measures” perspective and an “anchored measures” perspective, allow a user to discern those items containing unusually high or low measures, by including at least one view displaying data for two or more measures.

By interactively selecting and labeling the largest bars, both in the positive and negative directions, extreme values may be highlighted. Row and column bar chart views, as well as a three-dimensional multiscape view, may be easily sorted for easy comparison and comprehension. The row and column dimensional bar chart views may show margin totals. By tying color to either a dimension or a measure, the information-carrying capacity of the visual display may increase.

By visually manipulating the row, column, and page dimensions, navigation through the pivot table may be facilitated. The anchored measures and multiple measures perspectives provide unique and novel ways to visualize several measures simultaneously. These perspectives enable users to discover interactions among several measures. By interactively selecting important regions of the data and focusing in on those selected regions by excluding unselected data, users are able to see details within context.

The multi-dimensional data visualization systems and methods may provide a toolbar that provides a rich selection mechanism, making it possible, for example, to focus in on arbitrary regions of a pivot table. When connected directly to a multi-dimensional database engine, the multi-dimensional data visualization systems and methods provides users with the ability to access sub-cell detailed data.

Real analysis sessions include both visual analysis and textual analysis. Using the multi-dimensional data visualization systems and methods, users can visually select significant subsets of the multi-dimensional data structure, e.g., regions where a particular product may not be profitable, and export the subset back to the data source as a new multi-dimensional data structure for further textual and/or visual analysis.

Thus, using the multi-dimensional data visualization systems and methods, users are able to easily analyze pivot tables, or other multi-dimensional data structures, having several hundred rows and columns, eliminating the need to decompose a cube into sets of sub-cubes.

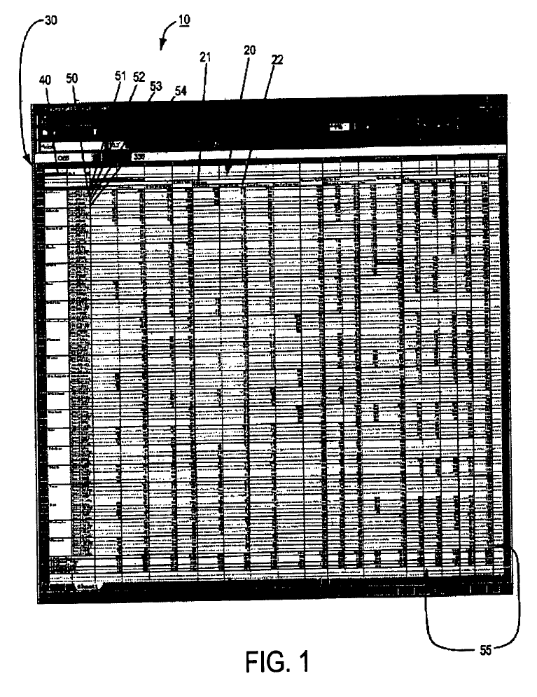

FIG. 7 shows one exemplary embodiment of a single measure perspective 100. The single measure perspective may be used to visualize the pivot table shown in FIG. 1. The data visualization systems and methods are able to read the pivot table data directly from an Excel® worksheet. The single measure perspective presents the entire pivot table for a selected measure. The pivot table data may be flattened to 2 dimensions and may be used as input data to the single measure perspective shown in FIG. 7. In the exemplary embodiment of the single measure perspective, which uses a three-dimensional multiscape view, the dimensions of the cube, or pivot table, are used as the X and Y axes for the three-dimensional multiscape view. The measure, i.e., the quantity displayed at the intersection of the dimensions, may be used as the value/weight of the glyphs that extend along the Z axis. The weight determines the size of the glyphs.

In the exemplary embodiment of the single measure perspective shown in FIG. 7, the measure “profits” may be visualized. However, it should be appreciated that the single measure perspective may be used to visualize any measure contained in the particular pivot table being visualized. Additionally, as discussed in greater detail below, the particular measure being visualized in the single measure perspective may be switched at will by the user between any measure contained in the particular pivot table being visualized.

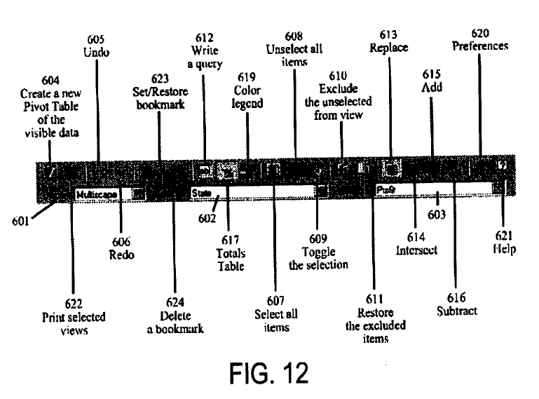

As shown in FIG. 7, the single measure perspective may be displayed using a standard graphical user interface that may be organized into a number of portions. These portions can include a toolbar 130, a dimensional view portion 110, a single measure view portion 120 and an optional totals table portion 140. The toolbar extends across the top of the exemplary embodiment of the single measure perspective shown in FIG. 7. However, it should be appreciated that the toolbar may be located anywhere in the graphical user interface. The various control functions implemented in the toolbar are discussed below in greater detail with respect to FIG. 12. The various drop-down and pop-up menus and buttons used to implement this toolbar follow the standard Microsoft conventions.

The dimensional view portion 110 includes one or more interactive dimensional views 112. In the exemplary embodiment of the single measure perspective shown in FIG. 7, the dimensional view portion may be implemented as a bar chart view portion. The exemplary embodiment of the bar chart view portion shown in FIG. 7 includes three interactive bar chart views that are positioned along the left edge of the graphical user interface. In particular, in the exemplary embodiment of the single measure perspective shown in FIG. 7, one dimensional view may be displayed in the dimensional view portion for each dimension of the selected measure. For the profit measure of the pivot table shown in FIG. 1, these dimensions include product_type, product and state. Thus, the three dimensional views show the profits totaled by product_type, by product, and by state, respectively. The dimensional view portion of the exemplary embodiments of the single measure and multiple measures perspectives shown in FIGS. 7-9 can also include a pages portion 114 that includes a page combo box that allows the user to select the page of data to be displayed. The dimensional view portion also includes a slider bar portion 116 that allows the user to move, add or remove various dimensional views from the dimensional view portion and various drop-down menus from the page combo box of the pages portion.

In the exemplary embodiments of the single measure and multiple measures perspectives shown in FIGS. 7-9, the dimensional views are bar chart views. However, it should be appreciated that any graphical representation of aggregated data on a dimensional basis may be used in the dimensional view portion in place of the bar chart views shown in FIGS. 7-9. For example, another common dimensional view may be the pie chart view (not shown). Other types of dimensional views include line charts, hierarchical charts, bubble plots, and the like.

It should be appreciated that, if the particular dimension being visualized has more or fewer measures, the number of dimensional views in the dimensional view portion may change to correspond to the number of measures that the selected dimension has. Moreover, it should further be appreciated that the dimensional view portion may be manipulated by the user to hide various dimensions, as discussed in greater detail below.

In the exemplary embodiment of the single measure perspective shown in FIG. 7, the single measure view portion includes a three-dimensional landscape view, called a three-dimensional multiscape view. However, it should be appreciated that any known or later developed view that allows all of the data of a single measure to be visualized at the same time may be used in the single measure view portion. In the exemplary embodiment of the single measure perspective shown in FIG. 7, the multiscape view of the single measure view portion may be positioned in the center of the graphical user interface. For the profit measure of the pivot table shown in FIG. 1, the multiscape view in FIG. 7 shows the profit by a product-state combination. Thus, the height, or depth for negative values, of each multiscape glyph along the z-axis represents the profits, or losses, respectively, for a particular product within a particular state. The products are arranged along the x (or y) axis grouped by product type.

In the exemplary embodiment of the single measure perspective shown in FIG. 7, the totals table portion may be positioned at the bottom left hand corner, and contains a totals table. For the measure currently displayed, such as, for example, profit in the exemplary embodiment of the single measure perspective shown in FIG. 7, the totals table shows the sum of that measure for all data items in the data pool, the sum of that measure for the selected items and the percent of the entire data set that may be selected. Some measures can have both positive and negative values. In this exemplary embodiment of the totals table, the data items with positive values are separated from the data items with negative values. Similarly, the data items with positive values are summed separately from the data items with negative values and the positive and negative data items are listed separately under the corresponding positive and negative columns.

The dimensional views present pivot table marginal totals, such as, for example in FIG. 7, the aggregation of profits by dimension value. In contrast, the multiscape view shows the cell detail. Moreover, the multiscape view gives the “big picture” overview of the pivot table. In the single measure perspective, the dimensional views have two purposes. First, the dimensional views give summarized detail about the values of the dimensions. Second, the dimensional views act as filters in the visual analysis process. This is discussed in more detail below.

As shown in FIG. 7, the multiscape view also includes its own toolbar 160. This toolbar includes, from the right end, a “top-down/bottom-up view” button 161, a “horizontal view” button 162, a “home position view” button 163, a “zoom” button 164, a “horizontal rotation” button 165, a “arbitrary rotation” button 166, a “pan” button 167, a “select mode selection” button 168, a “resort rows/columns” button 169, a “blocks” button 170 and a “cylinder” button 171. The “top-down view” button changes the orientation of the three-dimensional multiscape views smoothly from the current orientation to an orientation where it appears the user may be looking down or looking up along the vertical axis. The “horizontal view” button changes the orientation of the three-dimensional multiscape views smoothly from the current orientation to an orientation where it appears that the user may be looking at the three-dimensional multiscape view along the horizontal plane. The “home position” button returns the orientation of the three-dimensional multiscape view from its current position to the home orientation and zoom shown in FIG. 7.

The zoom button provides the standard zoom function. The “horizontal rotation” button places the three-dimensional multiscape view into the horizontal orientation and then rotates the three-dimensional multiscape view about an axis that may be parallel to the vertical axis but which passes through the center of the horizontal plane of the three-dimensional multiscape view. The “arbitrary rotation” button allows the user to arbitrarily rotate the three-dimensional multiscape view about an arbitrary axis, by linking the direction and amount of movement of the mouse to the rotational axis and the amount of rotation of the three-dimensional multiscape view.

The “pan” button allows the user to pan the three-dimensional multiscape view left, right, up and down using its current orientation. The “select mode selection” button returns the mouse to a selection mode to allow the user to select a portion of the three-dimensional multiscape view. The “re-sort rows/columns” button allows the user to alter which dimensions are associated with each axis of the three-dimensional multiscape view.

The “blocks” button and the “cylinder” button allow the user to covert the displayed shapes of the glyphs representing the values of the measure for the various dimensions between a cylindrical shape and a rectangular prism shape.

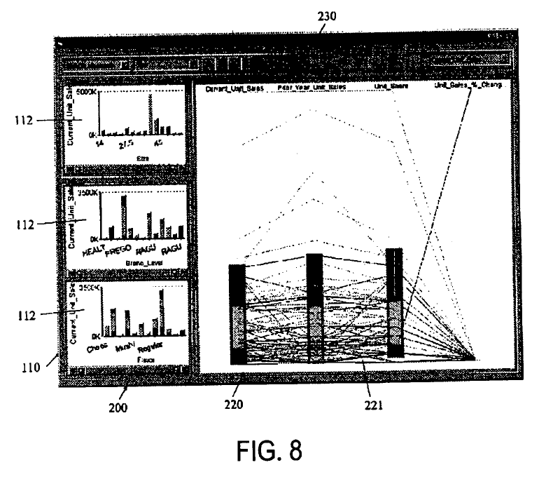

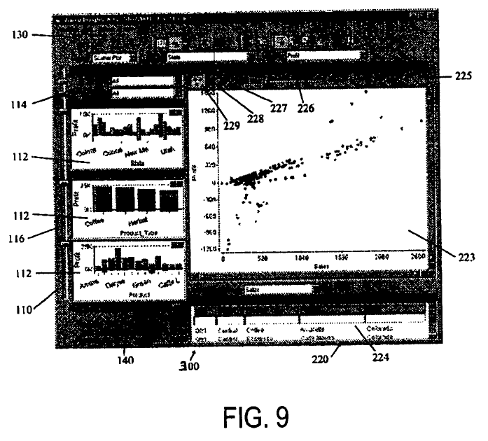

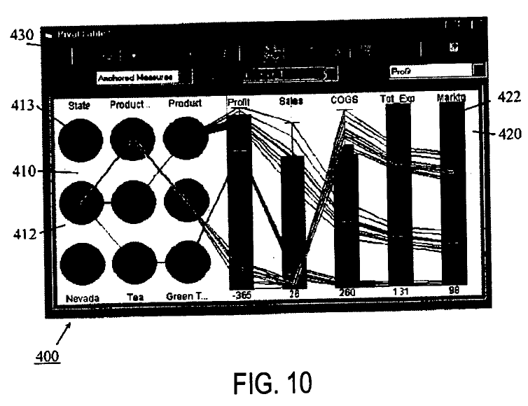

FIGS. 8 and 9 show a first exemplary embodiment 200 and a second exemplary embodiment 300, respectively, of a multiple measures perspective that may be usable to visualize the pivot table shown in FIG. 1. FIG. 10 shows one exemplary embodiment of an anchored measures perspective usable to visualize the pivot table shown in FIG. 1.

The multiple measures perspectives 100 and 300 shown in FIGS. 7 and 9 include the dimensional view portion of the single measure perspective but replaces the single measure view portion of the single measure perspective with a measures view portion 220 that includes a view that may be able to display several measures simultaneously. For example, the first exemplary embodiment of the multiple measures perspective shown in FIG. 8 includes a parabox view portion 221 as the measures view portion, while the second exemplary embodiment of the multiple measures perspective shown in FIG. 9 includes a scatterplot view portion 223 as the measures view portion. The parabox view is described in detail in co-pending U.S. Pat. No. 6,356,285, filed Dec. 17, 1997, herein incorporated by reference in its entirety. However, it should be appreciated that any known or later developed view that that allows data of two or more measures to be visualized at the same time may be used in the measures view portion.

In particular, relative to the single measure perspective shown in FIG. 7, the multiple measures perspective shown in FIG. 8 replaces the multiscape view with a weighted parabox view. The weighted parabox view combines a box plot view and a parallel coordinate view representation to show several measures simultaneously. In various exemplary embodiments, the parallel coordinates view may be implemented as a series of lines extending between the box plots of the box plot view portion.

The first exemplary embodiment of the multiple measures perspective shown in FIG. 8 does not include the totals table portion. The first exemplary embodiment of the multiple measures perspective shown in FIG. 8 also uses a second exemplary embodiment of the dimensional view portion that does not include the page combo box portion or the slider bar portion. Finally, the first exemplary embodiment of the multiple measures perspective shown in FIG. 8 replaces the toolbar 130 used in the single measure perspective shown in FIG. 7 and the second exemplary embodiment of the multiple measures perspective shown in FIG. 9 with a second exemplary embodiment of a toolbar 230.

Alternatively, relative to the exemplary embodiment of the single measure perspective shown in FIG. 7, the second exemplary embodiment of the multiple measures perspective shown in FIG. 9 replaces the multiscape view in the single measure view portion 120 with a measures view portion 220 that includes the scatterplot view portion 223 and adds a data sheet portion 224 and a measures toolbar 225. The scatterplot view shows exactly two measures simultaneously. Showing two measures simultaneously highlights interactions between the visualized measures that may lead to answers about why a certain problem exists.

The measures toolbar 225 includes a point size slider bar 226, a spline line mode button 227, a straight line mode button 228, and a no line mode button 229. In the second exemplary embodiment of the multiple measures perspective shown in FIG. 9, the no line mode may be active. The point size slider bar allows the user to control the displayed size of the points in the scatterplot. The spline line mode, when active, draws a second-order or higher line that most appropriately fits the selected data points within the scatterplot. The straight line mode, when active, draws a first-order, or straight, line that most appropriately fits the selected data points within the scatterplot. As shown in FIG. 9, when the no line mode is active, no lines are drawn through the selected data points within the scatterplot.

In contrast to the second exemplary embodiment of the multiple measures perspective 300 shown in FIG. 9, relative to the single-measures perspective shown in FIG. 7 and the first exemplary embodiment of the multiple measures perspective shown in FIG. 8, the anchored measure perspective 400 shown in FIG. 10 replaces the dimensional view portion 110 with a second exemplary embodiment of the dimensional view portion 410. This second exemplary embodiment may be combined with, and thus extends, the parabox view 422 of a parabox view portion 420 so that the combined view may handle both continuous data, using the box plots view of the parabox view 422, and categorical data, using a bubble plot view 412 in the dimensional view portion 410. The bubble plot view includes one column 413 of bubble plots for each dimension.

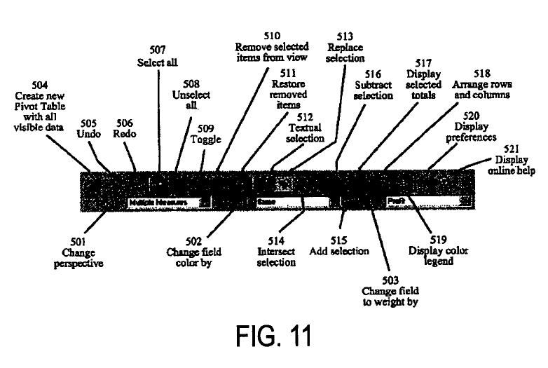

In the anchored measure perspective shown in FIG. 10, a third exemplary embodiment 430 of the toolbar may be located above the parabox view portion 420. However, it should be appreciated that the toolbar may be located anywhere in the graphical user interface. The various control functions implemented in the toolbar are discussed below in greater detail with respect to FIG. 11. Additionally, the pages portion 114 and the totals table portion 140 are omitted.

It should be appreciated that both the anchored measures perspective and the multiple measures perspective display several measures simultaneously. Showing several measures simultaneously in a single perspective allows interactions between measures to be highlighted. This in turn may lead to answers about why a certain problem exists in the system represented by the data stored in the multi-dimensional data structure being analyzed.

As shown in FIGS. 8 and 10, in the first exemplary embodiment of the multiple measures perspective and the exemplary embodiment of the anchored measures perspective, the dimensions and measures are organized along a series of parallel axes, as with a parallel coordinates plot. In the first and second exemplary embodiments of the multiple measures perspectives shown in FIGS. 8 and 9, the dimensions are visualized using the dimensional views of the dimensional views portion. In contrast, in the anchored measures perspective, the dimensions are visualized in a bubble plot view portion of the parabox view. In both the first exemplary embodiment of the multiple measures perspective shown in FIG. 8 and the exemplary embodiment of the anchored measures perspective shown in FIG. 10, the measures are visualized in a weighted box plot view portion of the weighted parabox view.

In the first and second exemplary embodiments of the multiple measures perspective shown in FIGS. 8 and 9, the same three dimensions, state, product_type and product, which correspond to the dimensions of the original pivot table, are shown as were shown in FIG. 7. Thus, the dimensional view portions of FIGS. 8 and 9 include the same three bar chart views as in FIG. 7. In the exemplary embodiment of the anchored measures perspective shown in FIG. 10, these same three dimensions are indicated by the three vertical bubble plot axes of the bubble plot view portion. As indicated above with respect to FIG. 7, if there are more or fewer dimensions for the selected measures to be displayed in the weighted parabox portion, the dimensional view portion of the single measures perspective and the bubble plot view portion of the anchored measures perspective may include more or fewer dimensional views.

In the first exemplary embodiment of multiple measures perspective shown in FIG. 8, the lines representing the parallel coordinates view are drawn between the box plot views of the weighted parabox view to connect the measure values. In the anchored measures perspective, the lines representing the parallel coordinates view are also drawn between the bubble plots of the bubble plot view portion and the box plot views of the box plot view portion of the weighted parabox view to connect the dimensions and the measure values.

In the first exemplary embodiment of the multiple measures perspective shown in FIG. 8 and the exemplary embodiment of the anchored measures perspective shown in FIG. 10, the outer boxes in the box plot views represent the range of values from the 5% percentile to the 95% percentile. The inner, dark gray box represents the range into which the middle 50% of the values fall, i.e. the 25th-75th percentiles. Outliers are values that are plotted outside, i.e., below or above, the outer box, i.e., below the 5th percentile or above the 95th percentile.

Each line in the box plots shown in the exemplary embodiments of the single and anchored measures perspectives shown in FIGS. 8 and 10 represents the measure values for one cell of the multi-dimension data structure. In the anchored measures perspective shown in FIG. 10, the sizes of the bubbles in the state, product_type, and product axes of the bubble plot view portion represent the number of cells in the multi-dimension data structure that have each respective selected value. The values of the measures from each row-by-column cell of the multi-dimension data structure are plotted as points on the vertical axis of the corresponding box plot view of the box plot view portion. From the first exemplary embodiment of the multiple measures perspective shown in FIG. 8 and the anchored measures perspective shown in FIG. 10, a user can easily identify measure values that are extreme values, or “outliers,” since these values are connected to extreme regions in the box plot views of the box plot view portion.

In the second exemplary embodiment of the multiple measures perspective shown in FIG. 9, the scatterplot view shows exactly two measures simultaneously. In particular, in FIG. 9, the profit and sales measures are visualized using the scatterplot view. Showing two measures simultaneously highlights interactions between the visualized measures that may lead to answers about why a certain problem exists. In the second exemplary embodiment of the multiple measures perspective shown in FIG. 9, data in the bar charts of the dimensional view portion and the corresponding points in the scatterplot view are colored using the same color.

As in the exemplary embodiment of the single measure perspective shown in FIG. 7, in the second exemplary embodiment of the multiple measures perspective shown in FIG. 9, the dimensional view portion may be positioned to the left of the scatterplot view and includes a number of bar chart views. However, as indicated above with respect to the exemplary embodiment of the single measure perspective shown in FIG. 7, the dimensional view portion of the second exemplary embodiment of the multiple measures perspective shown in FIG. 9 can include any known or later developed dimensional view.

Similarly, as in the exemplary embodiment of the single measure perspective shown in FIG. 7, in the second exemplary embodiment of the multiple measures perspective shown in FIG. 9, the totals table portion may be positioned in the lower left hand corner and displays positive and negative totals for the selected measure.

The main view in the second exemplary embodiment of the multiple measures perspective shown in FIG. 9 is the scatterplot view. In the second exemplary embodiment of the multiple measures perspective shown in FIG. 9, the user selects the measures that may be plotted on the X and Y axes of the scatterplot. Choosing different measures for the X and Y axes allows the user to compare the relationship of all available measures.

The scatterplot view may be useful for visually dividing the data into quartiles. Dividing the data into quartiles allows the user to quickly discern those data items that have low X and low Y values, low X and high Y values, high X and low Y values, and high X and high Y values. For example, if the profit measure and the sales measure are plotted, the user can easily see which products have low profits and low sales, which is generally to be avoided. These items can then be selected for further analysis. The scatterplot view may also be useful for identifying clusters of points and outliers and for analyzing correlations between different measures.

The data sheet portion may be used in the second exemplary embodiment of the multiple measures perspective shown in FIG. 9 to display a list of detailed information about selected points within the scatterplot view. The information for the point that is currently in focus appears in the top line, or the “focus line” on the data sheet portion. The remainder of the data sheet portion lists the detailed information for all other points that are selected in the scatterplot view.

In the exemplary embodiment of the anchored measures perspective shown in FIG. 10, four base measures, “profit,” “sales,” “COGS” (cost of goods sold), and “marktg” (marketing), and “tot_exp” (total expenses) are visualized in the weighted parabox view. In the first exemplary embodiment of the multiple measures perspective shown in FIG. 8, the lines extending between the box plot views are colored by product_type. Similarly, in the exemplary embodiment of the anchored measures perspective shown in FIG. 10, the lines extending between the bubble plot view and the box plot views are colored by product_type.

For example, for the exemplary set of data represented by the bubble plot views and box plot views shown in the exemplary embodiment of the anchored measures perspective shown in FIG. 10, the red lines corresponding to monthly green tea purchases in Nevada show losses in profit, i.e., negative profits, since these red lines touch the bottom of the Profit box plot. By noticing the values of the other measures connected by these red lines, a user can easily tell that the reasons for losses are: low sales, high cost of goods sold, and high marketing costs.

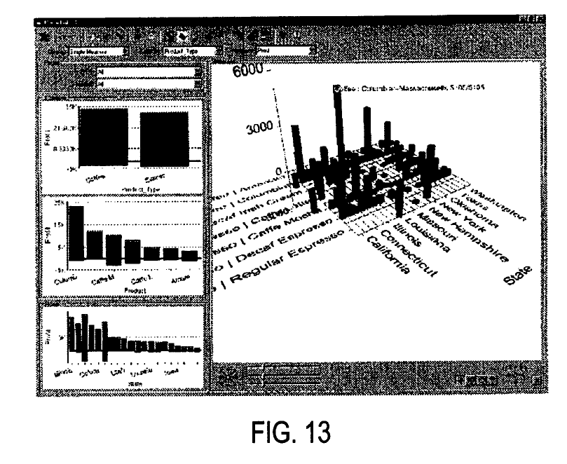

FIGS. 11 and 12 show the exemplary embodiments 430 and 130, respectively, of the toolbar for controlling the single measure, multiple measure and anchored measures perspectives and the data visualization systems and methods. In particular, the exemplary embodiment of the toolbar 430 shown in FIG. 11 may be particularly useful with the exemplary embodiments of the single measure perspective shown in FIGS. 13, 14 and 15, the exemplary embodiments of the anchored measures perspectives shown in FIG. 10 and the exemplary embodiment of the multiple measures perspective shown in FIG. 8. In contrast, the exemplary embodiment of the toolbar 130 shown in FIG. 12 may be particularly useful with the exemplary embodiment of the single measure perspective shown in FIG. 7, and the exemplary embodiment of the multiple measures perspective shown in FIG. 9.

The analysis power of the single measure, multiple measure and anchored measures perspective may be increased by providing efficient techniques to navigate through the visualization systems and methods. The navigational tool bar shown in FIG. 11 serves as a command and control center for navigating pivot tables and other multi-dimensional data structures.

The first and second exemplary embodiments of the toolbar shown in FIGS. 11 and 12 also include a number of graphical user interface menu items usable with the data visualization systems and methods. In various exemplary embodiments, the graphical user interface menu items of the navigational tool bar shown in FIG. 11 are implemented using Visual Basic composite control within a Visual Basic form so that the various perspectives shown in FIGS. 7-10 may be launched from Excel® (or from any other application, for that matter). Similarly, any other known or later developed language usable to implement a graphical user interface could be used to implement the graphical user interface menu items and buttons discussed herein.

Using the left-most drop-down menu, the user may switch between the single measure, multiple measure and/or anchored measures perspectives. The second drop-down menu allows the user to easily change the variable by which all the perspectives are colored by. The dimensions and measures available for coloring are those available from the pivot table data. The drop-down menu to the far right in FIG. 11 allows the user to select the measure that may be displayed in the multiscape. It should be appreciated that, in all the other views except the anchored measures perspective, this translates to the variable by which the view may be weighted.

Arranged across the top of the exemplary embodiment of the toolbar 430 shown in FIG. 11 are a displayed perspective drop-down menu 501, a color-by drop-down menu 502 and a displayed measure drop-down menu 503.

Arranged across the top of the exemplary embodiment of the toolbar 430 shown in FIG. 11 are, from left to right, a “write-back” button 504, “undo” and “redo” buttons 505 and 506, “select all,” “unselect all” and “toggle” selection mode buttons 507-509, “remove” and “restore” buttons 510 and 511 for removing or restoring the selected items from the perspectives, “text query,” “replace,” “intersect,” “add” and “subtract” selection mode buttons 512-516, a “display selected totals” button 517, an “arrange rows and columns” button 518, a “display color legend” button 519, a “display preferences” button 520 and an “online help” button 521. For example, the “arrange rows and columns” button allows the user to rearrange how the dimensions are grouped and displayed on the axes of the multiscape. The functions provided by these buttons are described in greater detail below.

Arranged across the top of the exemplary embodiment of the toolbar 130 shown in FIG. 12 are a displayed perspective drop-down menu 601, a color-by drop-down menu 602 and a displayed measure drop-down menu 603.

Arranged across the top of the second exemplary embodiment of the toolbar shown in FIG. 12 are, from left to right, a “writeback” button 604, a “print” button 622, “undo” and “redo” buttons 605 and 606, “set/restore bookmark” and “delete bookmark” buttons 623 and 624, a “textual query” selection mode button 612; a “display totals table” button 617, a “display color legend” button 619, “select all,” “unselect all,” and “toggle” selection mode buttons 607-609, “exclude unselected” and “restore excluded” buttons 610 and 611 for excluding unselected portions from the displayed perspectives and for restoring the excluded portions to the displayed perspectives, “replace,” “intersect,” “add,” and “subtract” selection mode buttons 613-616, a “display preferences” button 620 and an “online help” button 621.

It should be appreciated that essentially all of the features enabled by the toolbar buttons provided on the toolbars shown in FIGS. 11 and 12 can also be invoked via dropdown menus provided above the toolbar.

It should also be appreciated that all the inherent features and capabilities of the multiscape, parabox and bar chart components, as disclosed above or in the incorporated 408 application, are available to the user through respective pop-up menus accessed by inputting an appropriate user selection input. For example, one method for inputting an appropriate user selection input comprises placing a pointer within one of the multiscape, parabox or bar chart components using a mouse as a selection device, and then clicking the secondary button (which is usually the right mouse button on a right-handed mouse) on the mouse.

In particular, the exemplary embodiments of the toolbar shown in FIGS. 11 and 12 may include three classes of navigational controls. These navigational controls are directed, respectively, to controlling the displayed perspective, controlling how the perspectives are colored, controlling the measure displayed in the various perspectives. Additionally, the exemplary embodiment of the toolbar 130 shown in FIG. 11 includes a fourth class of navigational controls that controls how the dimensions of the pivot table are arranged. The “Display” controls 501 and 601 allow the user to select how the multi-dimensional data structure may be shown, either as a single measure perspective, a multiple measures perspective, an anchored measures perspective or any other implemented perspective. The “Color By” controls 502 and 602 allow the user to select which dimension or measure may be used to color all the views, i.e., the dimensional view, the multiscape view, the scatterplot view, the bubble plot views and/or the box plot views, or any other implemented view. The “Measure” controls 503 and 603 allow the user to set or select the displayed measure or measures, such as the measure displayed in the single measure perspective and the measures displayed in the scatterplot view of the multiple measures perspective. The pivot table dimensional arrangement control 518, described below, manipulate the rows and columns of the multi-dimensional data structure being analyzed.

The toolbars shown in FIGS. 11 and 12 may also include a number of function controls, including those for selection and visibility, which allow the user to focus and drill into interesting parts of the multi-dimensional data structure. The “write-back” function controls 504 and 604 allow the user to export a “result set” back to the data source application, such as Microsoft Excel®. The result set results from the user's analysis of the multi-dimensional data structure and may be a multi-dimensional data structure itself. This is described in greater detail below.

Using a mouse or any other known or later developed selection device, a user may sweep out regions on the views. The items in the swept-out region become the selection set and are drawn in color. The unselected items are then redrawn in gray. There are four selection modes, “replace,” “intersect,” “add” and “subtract.” The “replace” selection mode may be the default mode and causes the new selection set to replace the previous selection set. The “intersect” selection mode combines the previous and current selection sets to form a new, necessarily smaller set. The “add” selection mode extends the previous selection set by forming a new effective selection set as a union with the previous selection set and the new selection set. The “subtract” selection mode removes the swept out region from the previous selection set.

In addition, since selection is so important, these modes are extended in the toolbar by adding three new selection modes, a “select all” selection mode, an “unselect all” selection mode and a “toggle” selection mode. The “select all” selection mode causes all entities to be selected. The “unselect all” selection mode causes all entities to be unselected. The “toggle” selection mode inverts the selection set. That is, in the “toggle” selection mode, those items that were previously selected become unselected, while those items that were previously unselected become selected.

Furthermore, because selection is so important, these modes are further extended in the toolbar by adding the “text” or “textual selection” selection mode buttons and functions 512 and 612. When the user selects the “text” button, a text string measure selection graphical user interface that may be usable with the data visualization systems and methods may be displayed. That is, after the user selects the “text” button from the toolbar, the user may be provided with a method of data selection that may be based on the value of a text string rather than the area swept by the mouse or other selection device. A text selection dialogue box of this graphical user interface allows the user to enter the selection mode, using a first drop down box, the measure from which to choose, using a second drop down box, and the condition and value for matching, using 3rd and 4th drop down boxes. In response, the currently displayed views may change such that only the data items matching the criteria stated in the “measure selection” box are selected. All other values may be unselected.

The “display totals table” buttons 517 and 617 cause the measure totals table section 140 that may be usable with the data visualization systems and methods to be displayed. In the exemplary embodiments shown in FIGS. 7 and 9, the totals table section may be positioned below the dimensional views portion. The measure totals dialog box displays the sum of the measure that may be selected and as a percentage of the entire data set. These values are dynamically updated as the user selects different portions of data.

As indicated above, in embodiments that use the toolbar 430, selecting the “arrange rows and columns” button 518 allows the user to rearrange the dimensional views, by causing one or more dimension views to be rearranged within the graphical user interfaces that are usable with the data visualization systems and methods. To add, remove, and rearrange the dimensional views shown in the various perspectives, in the single measure perspective, the available dimensions are listed in the displayed graphical user interface. If all dimensions are currently displayed in the perspective, all dimensions are listed in “columns,” “rows,” or “pages” sections. In the multiple measure perspective, the displayed dimensions are listed in a “column” section. If the visualization uses pages, then these are listed in an “available columns” section.

To add a dimension, the user may drag the dimension from the dimension list section to the appropriate section where the dimension is to appear. To remove a dimension from the perspective, the user may drag that dimension to the dimension list section. To rearrange the order of the dimensions, the user may drag the dimension to the location where that dimension is to appear in the visualization.

As indicated above, in embodiments that use the toolbar 130, the multi-dimensional data visualization systems and methods include a dimensional focus navigational control portion and technique 116 for manipulating the rows, columns and pages that are visualized in the various perspectives of the multi-dimensional data visualization systems and methods. Similarly, selection and visibility allow the user of the multi-dimensional data visualization systems and methods to focus on and drill into interesting parts of the visualized multi-dimensional data structure.

Using the dimensional focus navigational technique, the user can rearrange the dimensions after visualizing a pivot table or other multi-dimensional data structure, by swapping rows, columns, and pages.

The various dimensions of a pivot table or other multi-dimensional data structure displayed in the various perspectives of the multi-dimensional data visualization systems and methods may be rearranged within the various perspectives in any configuration. However, at least one row and at least one column dimension of the pivot table or other multi-dimensional data structure must be selected for display, such as, for example, in the dimensional views portion. Changes to the dimensions that are made in the data visualization do not affect data stored in the original pivot table or other multi-dimensional data structure.

The slider bar along the left side of the dimensional views portion may be used to move a dimension to a different location within the dimensional views portion. To rearrange the dimensions within the dimensional views portion, the user clicks on the slider corresponding to one of the dimensions and drags the corresponding slider to a new area.

For example, to change a row dimension to a column dimension, the user selects the slider of the slider bar portion 116 next to that row dimension and drags that slide to the column section. The bar chart view for that dimension moves from the row section to the column section. Simultaneously, in the exemplary embodiment of the single measure perspective, the dimensions arranged along the column and row axes of the multiscape view change to reflect the new arrangement of the dimensions. It should be appreciated that a dimension may be removed from the various perspectives by moving that dimension to the pages section 114 and ensuring that the page field of the page combo box is set to “ALL.”

In the multi-dimensional data visualization systems and methods, the user can select data in two ways; by using a mouse or other selection device, or by using a textual query. Using the mouse, the user may sweep out regions on the views. The items in the sweep out region become the selection set and are drawn in color. The unselected set is drawn in gray.

Using the “text” or “textual selection” selection mode button and function, or equivalently, using the menu selection “Select/Write a Query . . . ,” the user constructs a textual query by filling in the blanks in a query box. The items matching the conditions indicated in the query become the selection set and are drawn in color. Again, the unselected set is drawn in gray.

The visual data analysis of the data visualization systems and methods also provide the user with the ability to focus in on particular regions of interest. There are two aspects of the visibility capability implemented using the navigation toolbar: excluding unselected data and restoring excluded data. The exclude function eliminates the unselected data items from the graphical user interface, so that only the selected data set is visible. The restore function brings the previously excluded data items back, making them again visible on the graphical user interface. Working together, selection and exclusion are extremely powerful. Starting with a large multi-dimensional data structure, a user can quickly and easily identify unusual patterns and interactively select them. Using the exclude function, a user can easily drill-in and focus on the interesting regions of the multi-dimensional data structure.

For example, to compare how profits vary between the products “coffee” and “espresso,” a convenient strategy may be to select those products and exclude the other product types. To accomplish this in the single measure perspective, the user would use the dimensional views as filtering tools. For example, in the exemplary multi-dimensional data structure displayed in the exemplary embodiment of the single measure perspective shown in FIG. 7, the user would select, on the “product_type” bar chart, just those bars corresponding to “coffee” and “espresso.” Using the navigational toolbar, pressing the “exclude” button simplifies the perspective to these two coffees. FIG. 13 shows the exemplary embodiment of the single measure perspective shown in FIG. 7 after the “exclude” button may be used to exclude all but coffee and espresso. The resulting exemplary embodiment of the single measure perspective shown in FIG. 13 makes it immediately apparent that Colombian coffee may be quite profitable in Massachusetts and espresso may be extremely profitable in New York.

Performing visual data analysis using the data visualization systems and methods involves posing questions, formulating hypotheses, and discovering results. As part of a holistic analysis process, these results must translate into business actions that yield value. To achieve this, various exemplary embodiments of the data visualization systems and methods provide users with the ability not only to perform visual analysis, but to create new multi-dimensional data structures that capture the results, called a “result set,” of this visual analysis. A result set, which may be a sub-multi-dimensional data structure created by selecting and excluding, may be exported, or “written-back” to the data source application, such as Microsoft Excel®). The written-back result set then appears in the data source application, such as Microsoft Excel®), as a new pivot table on a new sheet.

Furthermore, since various exemplary embodiments of the data visualization systems and methods provide the ability to integrates with Microsoft Office®, important visualizations may be inserted in Microsoft PowerPoint® presentations, analyzed further in Microsoft Excel®, saved as “HTML” files and browsed using Microsoft Internet Explorer®, or distributed as text for further action.

The pivot table shown in FIG. 1 includes data representing a multi-quarter business profitability study. The complete dataset, stored as an Excel pivot table, contains a wide range of business metrics. Such a multi-quarter business profitability study could be used to study profitability by product and market, to identify profitability problems, and to highlight reasons for the problems. One particular use of such a multi-quarter business profitability study could be to maximize profitability in Nevada by adjusting the product mix.

In the master pivot table, the original dimensions included “QTR” (quarter), “months,” “market,” “state,” “mrkt size” (market size), “product type,”“product,” and “decaf” (whether the product is decaffeinated). The original pivot table also included the measures “profit,” “margin,” “sales,” “cogs” (cost of goods sold), “tot_exp” (total expenses), “marktg” (marketing), “payroll,” “misc” (miscellaneous), “inventory,” “opening,” “additions,” “ending,” “margin rat” (margin ratio), “profit ratio,” “bdgt_profit” (budgeted profit), “bdgt_margin” (budgeted margin), “bdgt_sales” (budgeted sales), “bdgt_cogs” (budgeted cost of goods sold), “bdgt_payroll” (budgeted payroll), “and “bdgt_additions” (budgeted additions).

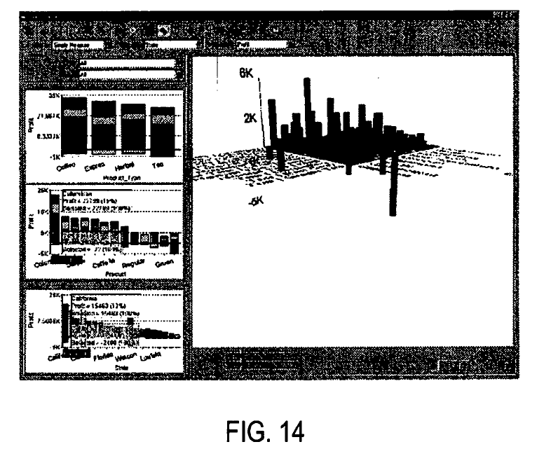

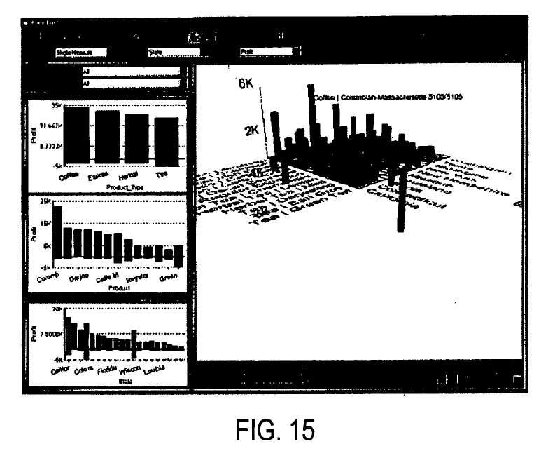

Focusing in on profitability, the exemplary embodiment of the single measure perspective shown in FIG. 14 shows profitability by product-state combination. Identifying the tallest bars by interactively touching the dimensional bar charts with the selection device shows that Colombian coffee may be the most profitable product overall and California may be the most profitable state. FIG. 15, which may be generated by rotating the multiscape view shown in FIG. 14 for better viewing of the bars and by labeling the tallest bars, shows that the most profitable product in any one state may be Colombian coffee, in Massachusetts, followed by Colombian coffee, in California.

Additionally, a user would also readily be able to notice also that one bar in FIG. 15 stands out, since it is large and points down, indicating a negative profit. Labeling this bar shows that it corresponds to Green Tea sales in Nevada. Selecting, excluding, and switching to the exemplary embodiment of the anchored measures perspective shown in FIG. 9 allows the user to quickly determine the performance of Green Tea in Nevada over the last several quarters.

It should be appreciated that the views in the various perspectives are linked by their use of a common, underlying data pool. The data in the data pool possesses properties such as color, focus and selection state. These properties manifest themselves similarly in each of the views of the various perspectives. When changes are made to one view in a particular perspective, the underlying shared data pool may be modified. This modification of the underlying data pool causes all other views in that perspective, as well as the views in the other perspectives, to change accordingly.

For example, in the single measure perspective, if the user selects a single bar from a bar chart view, then the other views in the single measure perspective may change to reflect the selection state made in that bar chart view. In FIG. 14, the bar for California was selected in the “state” bar chart view. The multiscape view was updated so that only those bars associated with the state of California are selected. The other bar chart views in the single measure perspective are updated so that the portion of their bars that are associated with California are also highlighted. Similarly, if the displayed perspective was changed to the second exemplary embodiment of the multiple measures perspective shown in FIG. 9, only the data points associated with California would be displayed in the scatterplot view.

The linked views feature may be important because it is the basis for visual querying. When views are linked via a common data pool, the user may be free to choose the perspective and/or the view that may be easiest to manipulate, using selection and excluding of data, to accomplish the desired visual query. The result of the visual query may be reflected by the other views in that perspective, and in the views of the other perspectives.

Thus, by switching to the exemplary embodiment of the anchored measures perspective shown in FIG. 10, the user can determine why there are losses by looking at the relationship of five measures: profits, sales, COGS (cost of goods sold), Tot_Exp (total expenses), and Marktg (marketing). The exemplary embodiment of the anchored measures perspective shown in FIG. 10 allows the user to discern a clear and consistent pattern, that whenever profits and sales of green tea are low, the cost of goods sold, the total expenses, and the marketing costs are high. The business problem is clear. A lack of green tea sales along with high costs are causing a large loss in Nevada.

Similarly, by switching to the second exemplary embodiment of the multiple measures perspective shown in FIG. 9, the user can determine why there are losses by looking at the relationship of five measures: profits, sales, COGS (cost of goods sold), Tot_Exp (total expenses), and Marktg (marketing), taking two at a time. This may be done by keeping the “profit” measure on the Y axis and cycling through the other measures on the X axis. The user may be interested only in this comparison for green tea in Nevada. Accordingly, the user selects just the “green tea” and “Nevada” bars from the bar chart views, leaving the unselected points to be displayed in gray for comparison. The second exemplary embodiment of the multiple measures perspective shown in FIG. 9 also allows the user to discern a similar clear and consistent pattern, that sales are low while profit may be low, and that COGS, Tot_Exp, and Marktg are high while profit may be low. As in the exemplary embodiment of the anchored measures perspective shown in FIG. 10, the second exemplary embodiment of the multiple measures perspective shown in FIG. 9 allows the user to determine that whenever profits and sales of green tea are low, the cost of goods sold, the total expenses, and the marketing costs are high. Again, the business problem is clear: a lack of green tea sales along with high costs are causing a large loss in Nevada.

It should be appreciated that any combination of the various perspectives discussed above may be used in the multi-dimensional data visualization systems and methods. Thus, in one exemplary embodiment, the multi-dimensional data visualization systems and methods include the single measure perspective and a multiple measures perspective that includes the scatterplot view of FIG. 9. Alternatively, in another exemplary embodiment, the multi-dimensional data visualization systems and methods include the single measure perspective, the multiple measures perspective that includes the scatterplot view of FIG. 9, and the anchored measures perspective. In a further exemplary embodiment, the multi-dimensional data visualization systems and methods include the single measure perspective and the multiple measures perspective that includes the parabox view of FIG. 8. In yet another exemplary embodiment, the multi-dimensional data visualization systems and methods include the single measure perspective, the multiple measures perspective that includes the parabox view of FIG. 8, and the anchored measures perspective. In still another exemplary embodiment, the multi-dimensional data visualization systems and methods include the single measure perspective and the anchored measures perspective.

It should further be appreciated that the multi-dimensional data visualization systems and methods can use any known or later developed single measure perspective in place of the single measure perspective shown in FIG. 7 and any of one or more known or later developed multi-measure perspectives in place of one or more of the multi-measure perspectives shown in FIGS. 8-10. Similarly, any known or later developed single measure view or multiple measure view may be incorporated into the single measure and/or the multi-measure perspectives of the multi-dimensional data visualization systems and methods.

Various exemplary embodiments of the multi-dimensional data visualization systems and methods integrate with Microsoft Office®D and either run as Microsoft Excel® application enhancements or connect directly to SQL Server®7.0. Multi-dimensional data may be pulled directly from the SQL Server through pivot table services. As part of the interface, the pivot table may be flattened and stored internally in data tables according to the multi-dimensional data visualization systems and methods. By flattening the tables, the multi-dimensional data visualization systems and methods enable the components to use case-based linking and focusing.

Various exemplary embodiments of the multi-dimensional data visualization systems and methods were written in Visual Basic®6.0. However, it should be appreciated that any other known or later developed appropriate language could be used to implement the multi-dimensional data visualization systems and methods discussed herein.

The visual components that make up the perspectives are implemented using ActiveX® controls attached to a single data table. However, it should be appreciated that any other known or later developed set of rules that define components could be used to implement the visual components that make up the perspectives of the multi-dimensional data visualization systems and methods discussed herein.

Various exemplary embodiments of the multi-dimensional data visualization systems and methods can accept data from Microsoft Excel® or directly from pivot table services. However, it should be appreciated that the multi-dimensional data visualization systems and methods may be implemented to accept data in any other known or later developed format.

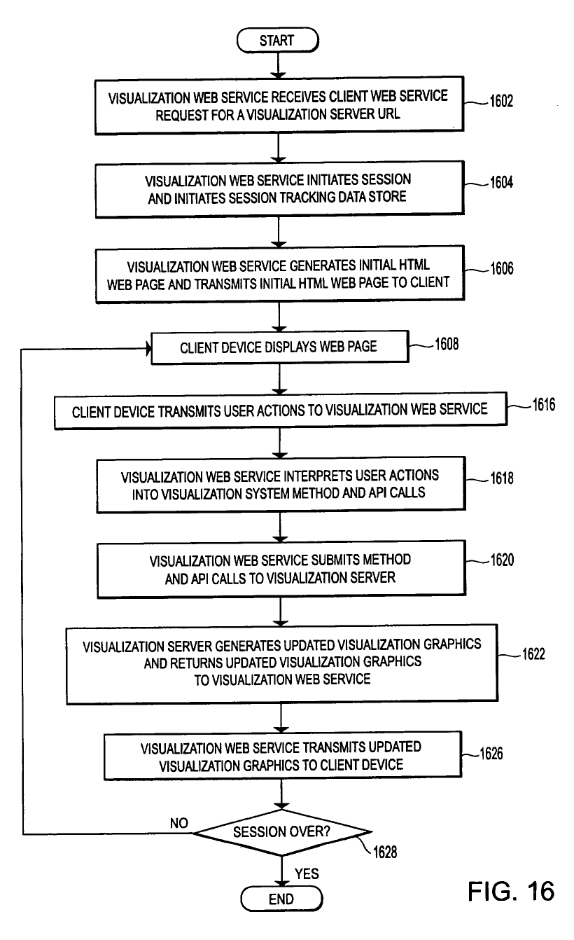

FIG. 16 is a process flow diagram depicting exemplary interaction between a client browser, the visualization web service, and the visualization server in support of a client browser initiated visualization session. As shown in FIG. 16, a request may be received from a client device web browser for a visualization URL at step 1602. Then, the visualization web service may, at step 1604, initiate a new visualization session and store an initial set of session tracking data. Next, at step 1606, the visualization web service may generate an initial HTML web page, transmit the initial HTML web page to the requesting client device, and update session tracking data to reflect the current status of the visualization session.

Upon receipt of the initial HTML web page, the requesting client device may display, at step 1608, the received web page. In response to a user interacting with the displayed visualization web page, at step 1610, scripts (e.g., JavaScript routines) embedded within the HTML document and/or visualization graphics may store the users actions and may transmit, at step 1616, the user actions to the visualization web service.

User actions recorded and transmitted to the visualization web service may include a variety of actions. For example, user actions may include, but are not limited to: starting another visualization session; identifying external sources to be loaded for use in a visualization; loading and exporting data to/from the visualization server; changing data selections for use in a visualization; changing visualization pages; changing visualization measures; changing colors assigned to data within visualization; changing a displayed perspective; and, changing a visualization table layout. Details related to exemplary user actions that may be performed by a user interacting with an exemplary, locally installed visualization server are described in U.S. Pat. No. 6,707,454, which is hereby incorporated by reference in its entirety. From a user's perspective, the interactive actions that may be performed via a client device web browser and the visualization results may be the same, or similar, to the interactive actions that may be performed and the visualization results that may be obtained by interacting with a locally installed visualization server.

Referring again to FIG. 16, user actions may be submitted at step 1616 to the visualization web service in response to a variety of user performed actions. Upon receiving a user action at step 1618, the visualization web service may translate the user action into appropriate method and/or API call(s) (e.g., as described with respect to Table 1 and Table 2, above) and may submit the method and/or API call(s) to the visualization server at step 1620. For example, information related to a user performed action may include interpreting the user performed action based upon a state of the visualization session, as stored in the visualization web service session tracking table, as described above.

Next, at step 1622, the visualization server may generate new and/or updated visualization graphics, and/or may perform data operations in accordance with the method and API calls received from the visualization web service and may return any generated visualization graphics to the visualization web service. In response to receiving new or updated visualization graphics, the visualization web service may transmit the updated visualization graphics to the client browser at step 1626.

Throughout the process flow described above, the visualization web service may maintain the status of each visualization session by updating status parameters within a session tracking data store, described above with respect to step 1604. If, at step 1628, the visualization web service determines that the client device session has been terminated by a user action (or by user inaction for a predetermined period of time), the visualization web service may terminate visualization server visual components (e.g., using method “DeleteSession,” described above with respect to Table 1) that are associated with the session and delete the session tracking data store maintained by the visualization web service to track the status of the visualization session.

As described above with respect to FIG. 3, the visualization server may be configured to receive user action information directly from a client web browser. In such an embodiment, the visualization web service may not be required to serve as an intermediary in all communications between the client browser and the visualization server. The process flow in such an embodiment may be similar to the process flow depicted above with respect to FIG. 16, with several exceptions. First, the client device may transmit user action information directly to the visualization server rather than via the visualization web service, as depicted in FIG. 16 at step 1616. Second, because the visualization web service would not be required to serve as an intermediary in all communications between the client browser and the visualization server, steps 1618 and 1620 shown in FIG. 16, would not be required when user actions are transmitted from the web browser directly to the visualization server. Third, the visualization server may generate updated visualization graphics in response to user action information received from the client browser and may return the updated visualization graphics directly to the client browser, and, therefore, the visualization server would not need to pass updated visualization results to the client browser via the visualization web service, as depicted in steps 1622 and 1624, when visualization server output is transmitted from the visualization server directly to the web browser.

In such an embodiment, a portion of the communication between the client browser and the visualization server may continue to be passed via the visualization web service in cases in which the services of the visualization web service are needed. For example, the visualization web service may continue to generate and transmit to the client device HTML with information received from visualization web server. Further, when the services of the visualization web service are needed, the visualization web service may continue to interpret user actions into visualization system method and API calls and to generate and transmit to the client device HTML based upon information received from visualization web server in response to the visualization web service submitted system method and API calls.

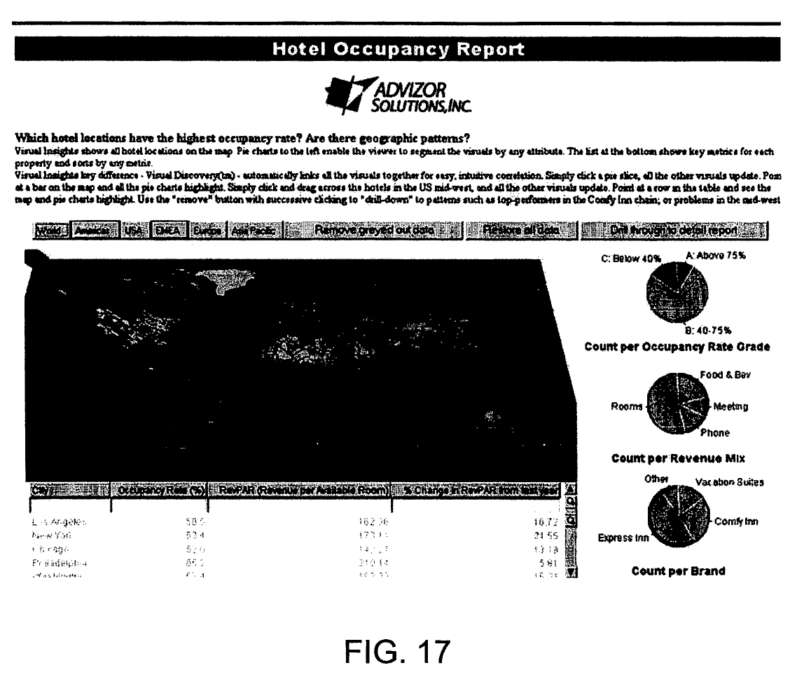

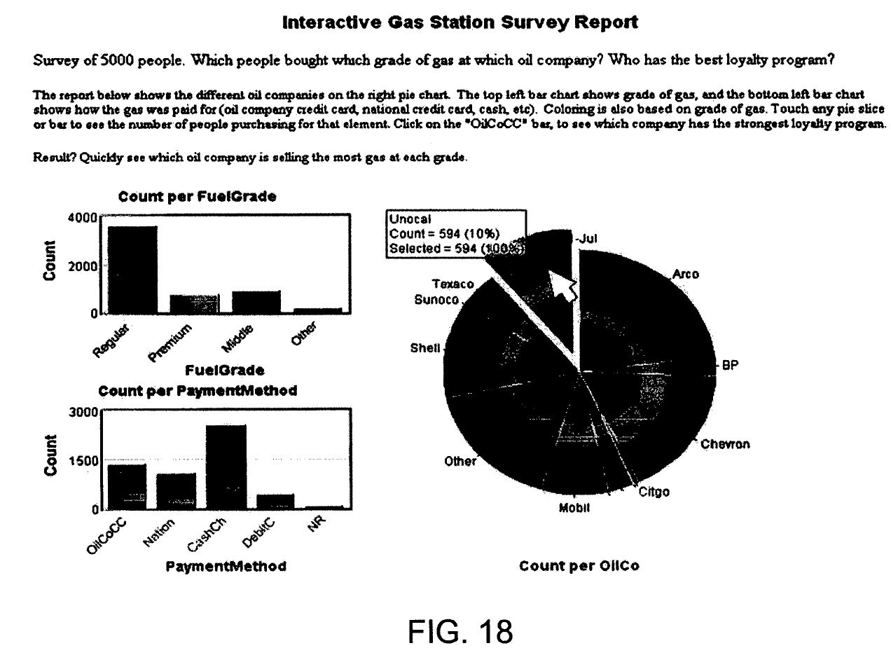

FIGS. 17 and 18 present exemplary HTML web pages that include visualization graphics that may be generated by the visualization server and incorporated within a HTML document, as described above. For example, FIG. 17 shows an exemplary HTML document that includes visualization graphics as part of a report on hotel occupancy. FIG. 18 shows an exemplary HTML document that includes visualization graphics as part of a gas station survey report. The HTML documents shown in FIGS. 17 and 18 may allow each user to interact with presented graphics to display views of the data that are of interest to the user, using the user interaction techniques described above and the process flow described above with respect to FIG. 16.

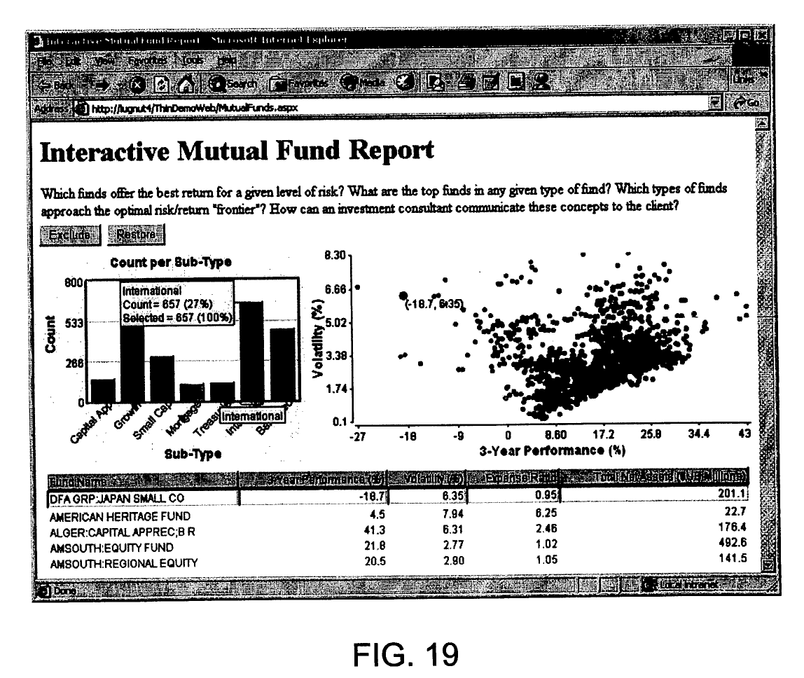

FIGS. 19-23 present further exemplary HTML web pages via which a user may manipulate the visualization graphics to observe views of the presented data. The visualization graphics presented in FIGS. 19-23 are based upon data tables that support automatic linking and correlation across simultaneous visual representations of data, as described above with respect to FIGS. 5 and 6. The linking and correlation between data tables permit interactions, such as filtering and drill-down, to be applied uniformly across the visualization graphics produced by the visualization server visualization components, as described with respect to FIGS. 5 and 6, thereby enabling a user to see patterns and explore relationships across several variables at once using a simple user interface.

FIG. 19 presents an HTML document that includes a bar-chart, scatterplot and tablular views of a selected set of data. As shown in FIG. 19, once a user clicks on one dot in the scatterplot, the coordinates of the selected dot may be displayed in the scatterplot adjacent to the dot. Likewise, the bar chart may update to show which bar the dot is a member of and the tabular views may update to show the target record at the top. In this manner, the selected data may be emphasized from amongst the data that has not been selected. Thus the user can see the details and the “big picture” simultaneously within a single screen. Such a user control may be referred to as a “focusing” event and may be implemented in a zero-footprint architecture using the process flows described above with respect to FIG. 16.

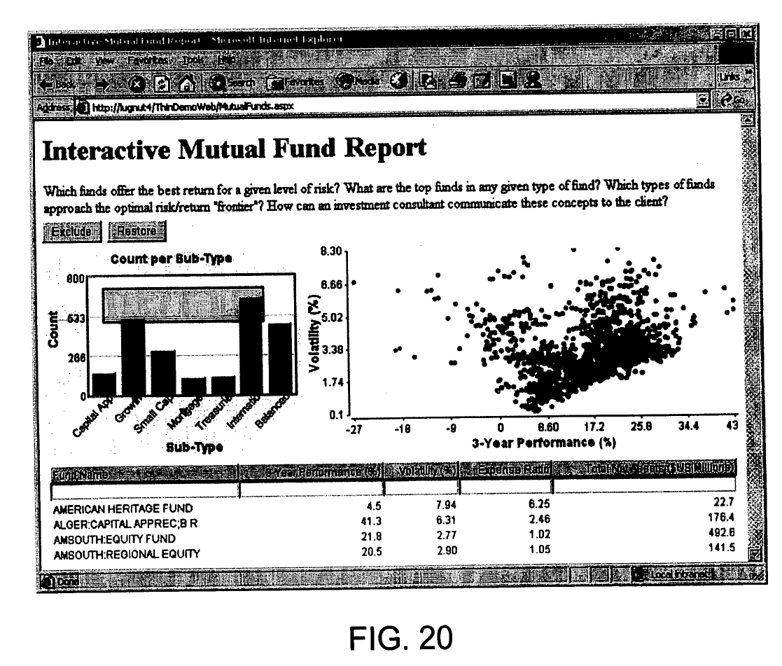

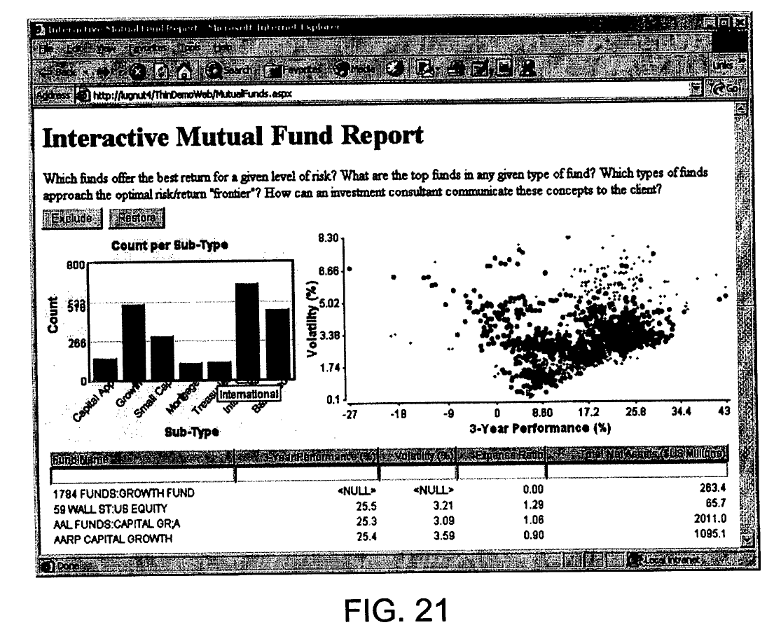

FIGS. 20-21 present an example of the effects of a second user interface control that may be referred to a “selection” event. For example, as shown in FIGS. 20 and 21, a user may select the tallest bars in a bar chart by clicking and dragging across the tall bars. In response, as shown in FIG. 21, all the visualization graphics may be updated to highlight just the selected elements in the bar chart, scatterplot and table. All other data may be “grayed out”. In this manner, the selected data may be emphasized and the data that has not been selected may be de-emphasized. Further, a user may select dots within a scatter chart to cause the related information within the bar chart and tabular data to be updated to reflect the new selection. In addition, a user may select one or more elements in the tabular data in order display the corresponding information in the bar and scatterplots. In each case, the respective visualization graphics may be updated in a manner that emphasizes the selected data and de-emphasizes the data that has not been selected. Each of these alternative selection events may be implemented in a zero-footprint architecture using the process flows described above with respect to FIG. 16.

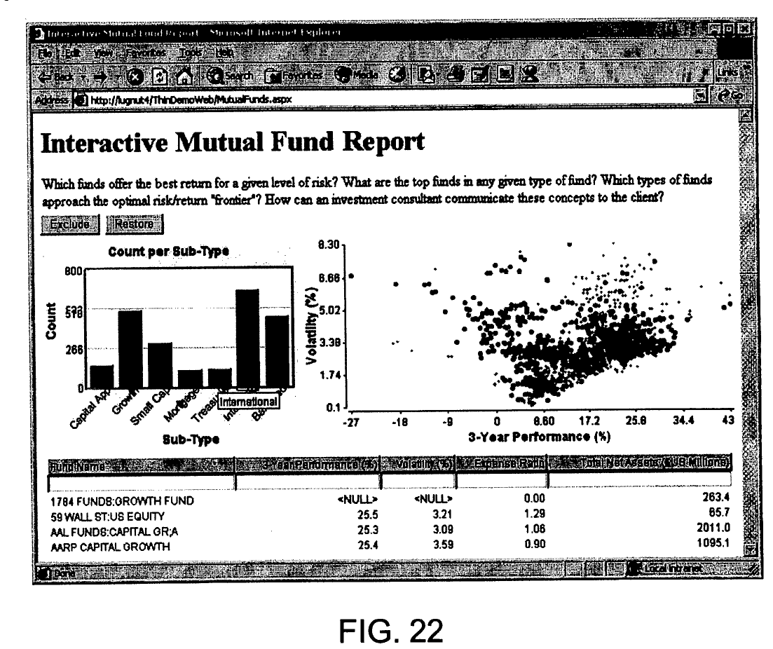

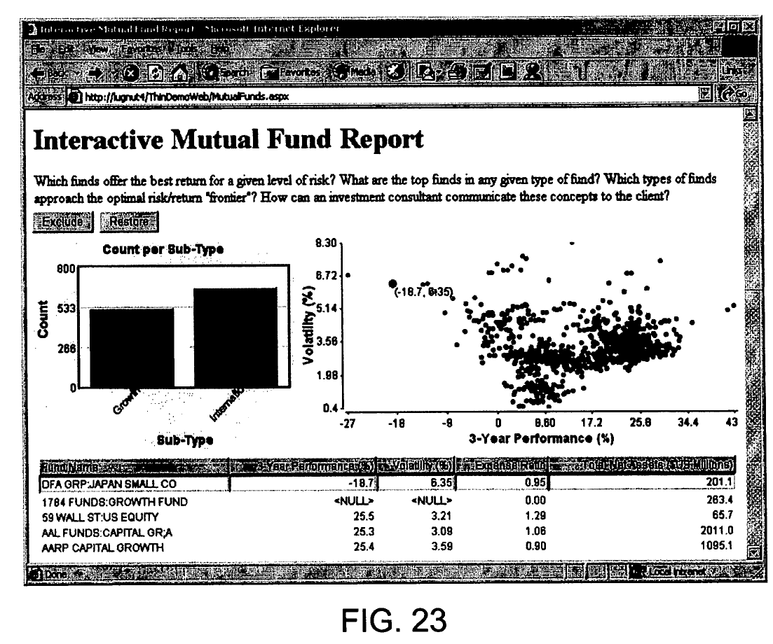

FIGS. 22-23 present a third exemplary user interface control that may be referred to a “drill-down” event. For example, after a selection event has been performed, as described above with respect to FIGS. 20-21, a user may remove the non-selected data to achieve a drill-down. The user simply clicks on an “Exclude” button that may be included within the HTML document and the visualization graphics may update so that all the “grayed out” data removed. For example, as shown in FIGS. 22-23, upon clicking the “Exclude” button,” all grayed out data is removed from FIG. 22, resulting in FIG. 23. Such a feature may be implemented in a zero-footprint architecture using the process flows described above with respect to FIG. 16. Scatterplot and table automatically may be automatically resized to show just the selected subset of data. Repeatedly using selection and exclusion empowers users to isolate subsets of data based on any combination of data attributes. In this manner, the selected data may be emphasized and data that has not been selected may be de-emphasized by being removed.

Although not explicitly shown in FIGS. 19-23, the bar chart, navigation, such as zooming, panning and rotating scenes in 2D and 3D may be accomplished with slider bars. The slider bars may be clicked and dragged, when released a new image may be generated appropriately. Further, other interactions, such as adjusting the sort order of a bar chart; or assigning a data attribute to coloring, may be accomplished with buttons presented upon the HTML page, or via a toolbar presented on the page, as described above with respect to FIGS. 11 and 12, above. An HTML document may be configured to include any or all features supported by the visualization server to control the manipulation and/or presentation of data. The buttons and/or other controls included within an HTML document may depend upon the nature of the visualization graphics to be displayed and the degree of control that is to be provided to the user. For example, tool bars similar to those described with respect to FIGS. 11 and 12 may be used, however, such toolbars may include a greater number or a lesser number of features and/or different features and/or combinations of features.

Regardless of the HTML document presented, the number of visualization graphics displayed and/or the number of controls presented, the end-user has a fully interactive visualization without any overhead on their computer; other than a standard web browser. User interactions may be processed and displays to the user may be seamlessly presented using the process flows described above with respect to FIG. 16.

User action information may be interpreted in any manner to determine the significance of a user action with respect to displayed functional controls (e.g., buttons, scroll bars, toolbars, etc.) and/or with respect to displayed data within the respective visualization graphics. For example, coordinates associated with a user mouse-click may be interpreted to determine whether data or a functional control has been selected and to generate an appropriate response to the user action, based upon the process flows described with respect to FIG. 16. Similarly, user action information related to a “click-drag-release” may be interpreted to determine whether (and what) data has been selected, or how a control (e.g., a scroll bar) has been manipulated. Other user actions may be similarly processed.

User action information may be interpreted by any module or component within the zero-footprint architecture described above. For example, user action information may be interpreted by the client web browser, the scripts embedded within a displayed HTML document, and/or modules within the visualization web service and/or the visualization server. For example, standard scripts within the web browser may generate user action physical information (e.g., the physical action performed and cursor coordinates associated with the physical action performed) based upon input received from input devices connected to the client device. Further, user action information may the be interpreted by scripts embedded within the displayed HTML document and/or embedded within the visualization web service to translate the user action into methods and API calls that may be passed to and understood by the visualization server.

In addition, user action information (e.g., the physical actions performed and cursor coordinates associated with the respective physical actions) passed to the visualization server may be further processed and analyzed. For example, visual components within the visualization server may use the user action information to determine whether the user action corresponds to the selection of a functional button, operation of an operational feature (e.g., a navigational slide-bar), or whether the user action corresponds to a selection of data within a displayed visualization graphic. For example, the visualization server visual components (as described with respect to FIGS. 4-6) may assess cursor coordinates associated with a user action to determine whether (and what) data has been selected by a user action. A visual component may then update a display status associated with the associated data stored in its respective data pool table. Such data pool table changes may then be propagated by the data pool to all related data pool tables, resulting in each affected visual component being notified of the respective data table changes. Each affected visual component may then updates its respective visualization graphic, if necessary. Each updated visualization graphic may then be transmitted to the client web browser, either directly or via a visualization web service, as described above with respect to FIGS. 3 and 16.

It will be appreciated that the embodiments described above and illustrated in the drawings represent only a few of the many ways of implementing an enterprise-wide multi-dimensional data visualization system based upon a client zero footprint architecture. The present invention is not limited to the specific embodiments described herein, but may include system that facilitates enterprise-wide deployment of multi-dimensional data visualization capabilities based upon a client zero-footprint architecture.

The described visualization web service and visualization server embodiments may be implemented in any number of modules and are not limited to the software module architecture described above. Each module may be implemented in any number of ways and are not limited in implementation to execute process flows precisely as described above. The visualization web service and visualization server processes described above and illustrated in the flow charts and diagrams may be modified in any manner that accomplishes the functions described herein.

It is to be understood that various functions of the visualization web service and visualization server method and apparatus may be distributed in any manner among any quantity (e.g., one or more) of hardware and/or software modules or units, computer or processing systems or circuitry.

Visualization web service and visualization server processing module(s) may be integrated within a stand-alone system or may execute separately and be coupled to any number of devices, workstation computers, server computers or data storage devices via any communications medium (e.g., network, modem, direct connection, etc.). The visualization web service and visualization server process may be implemented by any quantity of devices and/or any quantity of personal or other type of devices computer or processing system (e.g., IBM-compatible, Apple, Macintosh, laptop, palm pilot, microprocessor, etc.). The computer system may include any commercially available operating system (e.g., Windows, OS/2, Unix, Linux, DOS, etc.), any commercially available and/or custom software (e.g., communications software, etc.) and any types of input devices (e.g., keyboard, mouse, microphone, I/O port, etc.).

It is to be understood that the software of the visualization web service and visualization server process may be implemented in any desired computer language, and could be developed by one of ordinary skill in the computer and/or programming arts based on the functional description contained herein and the flow charts illustrated in the drawings. For example, in one embodiment the visualization web service and visualization server process may be written using the C++ programming language, however, the present invention is not limited to being implemented in any specific programming language. The various modules and data sets may be stored in any quantity or types of file, data or database structures. Moreover, the visualization web service and visualization server software may be available or distributed via any suitable medium (e.g., stored on devices such as CD-ROM and diskette, downloaded from the Internet or other network (e.g., via packets and/or carrier signals), downloaded from a bulletin board (e.g., via carrier signals), or other conventional distribution mechanisms).

The format and structure of internal structures used to hold intermediate information in support of the visualization web service and visualization server process may include any and all structures and fields an are not limited to files, arrays, matrices, status and control booleans/variables.

The visualization web service and visualization server software may be installed and executed on a computer system in any conventional or other manner (e.g., an install program, copying files, entering an execute command, etc.). The functions associated with a system that uses visualization web service and visualization server (e.g., generation of one or more visual graphics components, etc.) may be performed on any quantity of computers or other processing systems. Further, the specific functions may be assigned to one or more of the computer systems in any desired fashion.

The visualization web service and visualization server process may accommodate any quantity and any type of data set files and/or databases or other structures containing stored data sets, measured data sets and/or residual data sets in any desired format (e.g., ASCII, plain text, any word processor or other application format, etc.).

Visualization web service and visualization server output may be presented to the user in any manner using numeric, alphanumeric and/or visual presentation formats.

User actions may be stored and/or transmitted to the visualization web server and/or visualization server using any encoding technique. Such encoding techniques may include, but are not limited to the use of an XML document.

Encoded user action information may include information related to any user performed action performed using any input device including input receives from a user keyboard, mouse, joystick, foot-petals or other input device. Any input device may be used that may generate user action information related to user interaction with a displayed document (e.g., HTML document) with embedded visualization graphics. User action information may include but is not limited to: mouse single-click coordinates; mouse double-click coordinates; mouse click-drag-and-release coordinates; combinations of left, right and center mouse-clicks, scroll wheel input; screen cursor coordinates, keyboard entries, joystick actions, etc.

The visualization web service may be implemented as an Application Interface (API) wrapped around the visualization server or in any other manner that is capable of supporting the above described functional capabilities.

The described visualization HTML documents above are exemplary only. The described visualization server may be used to generate HTML documents with any or all of the capabilities and features described. Further, the presentation formats and user interaction capabilities that may be presented to a user using the zero-footprint architecture described above are not limited to those described, but may include any presentation format and user interaction capability.

Further, any references herein of software performing various functions generally refer to computer systems or processors performing those functions under software control. The computer system may alternatively be implemented by hardware or other processing circuitry. The various functions of the visualization web service and visualization server process may be distributed in any manner among any quantity (e.g., one or more) of hardware and/or software modules or units, computer or processing systems or circuitry, where the computer or processing systems may be disposed locally or remotely of each other and communicate via any suitable communications medium (e.g., LAN, WAN, Intranet, Internet, hardwire, modem connection, wireless, etc.). The software and/or processes described above and illustrated in the flow charts and diagrams may be modified in any manner that accomplishes the functions described herein.

From the foregoing description it will be appreciated that the present invention includes a novel system and method for implementing an enterprise-wide multi-dimensional data visualization system based upon a client zero footprint architecture. It will be appreciated that the embodiments described above and illustrated in the drawings represent only a few of the many ways of implementing an enterprise-wide multi-dimensional data visualization system based upon a client zero footprint architecture. Therefore, the present invention is not limited to the specific embodiments described herein, but may include any system that facilitates enterprise-wide deployment of multi-dimensional data visualization capabilities based upon a client zero-footprint architecture.

Nothing in this disclosure should be interpreted as limiting the present invention to any specific visualization graphical presentation formats. Nothing in this disclosure should be interpreted as requiring any specific manner of representing mult-dimensional data.

Each visual component (e.g., 2410(a-n) in FIG. 5) may embody any visual representation including conventional graphs such as bars, pies, and lines, as well as special purpose metaphors such as data constellations. Exemplary visual representations are described in U.S. Pat. No. 6,707,454, which is incorporated herein it its entirety.

While specific embodiments of systems and methods for enterprise-wide visualization of multi-dimensional data are disclosed, these embodiments should be viewed as illustrative, not limiting. Various modification, improvements and substitutes are possible within the scope of the present invention. Although specific terms are employed herein, they are used in their ordinary and accustomed manner only, unless expressly defined differently herein, and not for purposes of limitation.

What is claimed is:

1. A method for presenting information to a user via a remote display device, the method comprising:
generating a document that includes a plurality of graphical views of data stored within a data store, wherein the plurality of graphical views use a plurality of presentation formats to represent the stored data;
transmitting the document to the remote display device;
receiving input from the remote display device that identifies a portion of a graphical view of the plurality of graphical views;
determining the data within the data store that corresponds to the identified portion of the graphical view;
regenerating at least one graphical view based upon the data identified by the received input; and
transmitting the regenerated at least one graphical view to the remote display device.

2. The method of claim 1, wherein the regenerated at least one graphical view emphasizes the data identified by the received input.

3. The method of claim 1, wherein the input received from the remote display device includes at least one of:
input that indicates whether the identified data is to be at least one of emphasized and de-emphasized within the plurality of graphical views;
input that indicates a viewpoint from which to display at least one of the plurality of graphical views; and
input that provides panning information to be applied to at least one of the plurality of graphical views.

4. The method of claim 1, further comprising:
receiving input from the remote display device that identifies additional graphical views for inclusion in the document.

5. The method of claim 1, further comprising:
receiving input from the remote display device that determines the presentation format used for at least one of the plurality of graphical views included in the document.

6. The method of claim 1, wherein the remote display device is a web browser and the input received from the remote display device includes parameters captured by the web browser.

7. The method of claim 1, wherein the transmitted document is an HTML document and the plurality of graphical views are objects embedded within the HTML document.

8. The method of claim 7, wherein the plurality of graphical views are embedded within the HTML document as images.

9. The method of claim 1, wherein the generated document is generated based upon a stored default configuration.

10. The method of claim 1, wherein the generated document is generated based upon a user provided configuration.

11. A system for presenting information to a user via a remote display device, the system comprising:
a web service that:
generates a document that includes a plurality of graphical views of data stored within a data store, wherein the plurality of graphical views use a plurality of presentation formats to represent the stored data;
transmits the document to the remote display device;
receives input from the remote display device that identifies a portion of a graphical view of the plurality of graphical views;
generates instructions for regenerating at least one graphical view based upon the input received from the remote display device;
a visualization server that:
receives instructions from the web service for regenerating at least one graphical view based upon the input received from the remote display device;
regenerates at least one graphical view based upon the instructions received from the web service; and
transmits the at least one regenerated graphical view to the web service,
wherein upon receipt of the at least one regenerated graphical view, the web service generates and transmits to the remote display device the regenerated at least one graphical view.

12. The system of claim 11, wherein the visualization server further comprises:
at least one visualization component that:
receives commands from the visualization server; and
generates at least one graphical view based upon the commands received from the visualization server.

13. The system of claim 12, wherein the visualization server further comprises a data pool that includes a plurality of data tables, wherein each table may be linked to one or more of the at least one visualization component to provide data that supports generation of the at least one graphical view.

14. The system of claim 13, wherein the visualization server further comprises:
at least one data component that propagates changes to tables in the data pool in response to events that affect data stored in multiple tables.

15. The system of claim 12, wherein the at least one visualization component further includes a link to at least one data pool table, wherein the link causes the visualization component to regenerate the at least one graphical view upon determining that data in the data table upon which the at least one graphical view is based has changed.

16. The system of claim 12, wherein the visualization web service further includes a visualization session tracking data store that stores information related to a session.

17. The system of claim 13, further comprising:
a connection to an external data source that supports the loading of data from the external data source into the at least one table within the data pool.

18. A program product apparatus having a computer readable medium with computer logic recorded thereon for presenting multi-dimensional visualization graphics to a remote display device, said program product apparatus comprising:
a web service module that:
generates a document that includes a plurality of graphical views of data stored within a data store, wherein the plurality of graphical views use a plurality of presentation formats to represent the stored data;
transmits the document to the remote display device;
receives input from the remote display device that identifies a portion of a graphical view of the plurality of graphical views;
generates instructions for regenerating at least one graphical view based upon the input received from the remote display device;
a visualization server module that:
receives instructions from the web service module for regenerating at least one graphical view based upon the input received from the remote display device;
regenerates at least one graphical view based upon the instructions received from the web service module; and
transmits the at least one regenerated graphical view to the web service module,
wherein upon receipt of the at least one regenerated graphical view, the web service module generates and transmits to the remote display device the regenerated at least one graphical view.

19. The program product apparatus of claim 18, wherein the visualization server module further comprises:
a visualization component module that:
receives commands from the visualization server module; and
generates at least one graphical view based upon the commands received from the visualization server module.

20. The program product apparatus of claim 18, wherein the visualization server further comprises:
a data pool module that includes a plurality of data tables, wherein at least one table is linked to the visualization component module to provide data that supports generation of the at least one graphical view.
